(19) United States
(12) Patent Application Publication
(10) Pub. No.: US 2026/0064472 A1
(43) Pub. Date: Mar. 5, 2026

(54) PROCESSING UNIT FOR PROCESSING NEURAL NETWORK, ELECTRONIC DEVICE INCLUDING THE SAME, AND HOST PROCESSOR

(71) Applicant: Samsung Electronics Co., Ltd., Suwon-si (KR)

(72) Inventors: Jeongjoon YOO, Suwon-si (KR); Nahyun KIM, Suwon-si (KR); Dongjin YOOK, Suwon-si (KR); Buyoung YUN, Suwon-si (KR); Jaehee JUN, Suwon-si (KR); Hoonhee CHO, Suwon-si (KR); Isaac HONG, Suwon-si (KR); Kyongjoo OH, Suwon-si (KR); Jonghyuk EUN, Suwon-si (KR)

(73) Assignee: Samsung Electronics Co., Ltd., Suwon-si (KR)

(21) Appl. No.: 19/276,852

(22) Filed: Jul. 22, 2025

(30) Foreign Application Priority Data
Aug. 29, 2024 (KR) 10-2024-0116944
Sep. 13, 2024 (KR) 10-2024-0126187

(51) Int. Cl. G06F 9/50

(52) U.S. Cl. CPC G06F 9/5027

(57) ABSTRACT

A processing unit for processing a neural network includes a coordinator configured to receive a kernel command from a host processor, determine a type of kernel corresponding to the kernel command, and generate an additional command different according to the type of kernel, the kernel command being used to execute kernels required to process the neural network, and a command processor configured to schedule such that the data produced by the producing kernel is referred to when the consuming kernel is executed based on the kernel command and the additional command.

### CROSS-REFERENCE TO RELATED APPLICATIONS

This application is based on and claims priority under 35 U.S. C. § 119 to Korean Patent Application Nos. 10-2024-0116944, filed on Aug. 29, 2024 and 10-2024-0126187, filed on Sep. 13, 2024, in the Korean Intellectual Property Office, the disclosures of which are incorporated by reference herein in their entirety.

### BACKGROUND

The inventive concepts relate to a processing unit, and more particularly, to a processing unit for generating an additional command according to the type of kernel, an electronic device including the same, and a host processor.

With the high integration of semiconductor technology and the increase of machine learning performance, electronic devices, including mobile devices, may be configured to process and/or enable a neural network modeling.

Electronic devices may include not only a central processing unit (CPU) and memory but also various processing units, such as a graphics processing unit (GPU) processing graphics data, a neural processing unit (NPU) for internal operations of a neural network, a digital signal processor (DSP), and an image signal processor (ISP), etc. according to technological advances. Electronic devices may process a neural network by using a CPU in conjunction with other various processing units.

Interactions, such as data transfer, may occur in each kernel between a CPU requesting neural network processing and other processing units driving a neural network. This may cause performance degradation in electronic devices and reduce the opportunity for a CPU to be powered off.

Therefore, technology for reducing interactions between a CPU and other processing units, which occur during said data process, are being explored.

### SUMMARY

The inventive concepts provide a processing unit for minimizing interactions between a central processing unit and processing units by generating an additional command according to the type of kernel and allowing a consuming kernel to be executed, based on the additional command and a kernel command, by referring to data produced by a producing kernel, an electronic device including the processing unit, and a host processor.

According to an aspect of the inventive concepts, there is provided a processing unit for processing a neural network. The processing unit includes a coordinator configured to receive a kernel command from a host processor. the kernel command enabling an execution of kernels for a neural network process, determine a type of at least one of the kernels corresponding to the kernel command, the types of kernel including a producing kernel configured to produce data and a consuming kernel configured to refer to the data, and generate a different additional command based on the determined type of kernel; and a command processor configured to, based on the kernel command and the additional command, schedule the neural network process such that the data produced by the producing kernel is referred to when the consuming kernel is executed.

According to another aspect of the inventive concepts, there is provided an electronic device including a first processing unit configured to receive a producing kernel command corresponding to a producing kernel and execute the producing kernel based on the producing kernel command, the producing kernel configured to produce data; and a second processing unit configured to receive a consuming kernel command corresponding to a consuming kernel and execute the consuming kernel based on the consuming kernel command, the consuming kernel referring to the data, wherein the first processing unit is further configured to generate a first additional command that requests that an identifier, corresponding to the producing kernel command, be written to a first register of the first processing unit, and the second processing unit is further configured to generate a second additional command that requests a wait until an identifier, corresponding to the consuming kernel command, is written to a second register of the second processing unit.

According to a further aspect of the inventive concepts, there is provided a host processor including a user mode driver configured to drive a host program and to generate a kernel command configured to enable executing kernels for neural network processing; and a kernel mode driver configured to manage resources of a processing unit configured to execute the kernels, wherein one of the user mode driver and the kernel mode driver includes a command injector configured to generate a different additional command according to a type of the kernel command, enabling referencing between the kernels, and to output the kernel command and the additional command corresponding to the kernel command.

According to the further aspect of the inventive concepts, there is provided the host processor, wherein the command injector is further configured to generate a first additional command in correspondence to a producing kernel command for executing a producing kernel that produces data, wherein the first additional command requests to write an identifier corresponding to the producing kernel command to an internal register of the processing unit that executes the producing kernel.

According to the further aspect of the inventive concepts, there is provided the host processor, wherein the command injector is further configured to add the first additional command behind the producing kernel command to follow the producing kernel command.

According to the further aspect of the inventive concepts, there is provided the host processor, wherein the command injector is further configured to generate a second additional command in correspondence to a consuming kernel command for executing a consuming kernel that refers to data, wherein the second additional command requests to wait until an identifier corresponding to the consuming kernel command is written to an internal register of the processing unit that executes the consuming kernel.

According to the further aspect of the inventive concepts, there is provided the host processor, wherein the command injector is further configured to add the second additional command before the consuming kernel command to precede the consuming kernel command.

### BRIEF DESCRIPTION OF THE DRAWINGS

Embodiments will be more clearly understood from the following detailed description taken in conjunction with the accompanying drawings in which:

FIG. 1 is a block diagram of an electronic device according to at least one embodiment;

FIG. 2 is a diagram illustrating kernels according to at least one embodiment;

FIG. 3 is a block diagram illustrating a processing unit according to at least one embodiment;

FIG. 4 is a diagram illustrating a first additional command according to at least one embodiment;

FIG. 5 is a diagram illustrating a second additional command according to at least one embodiment;

FIG. 6 illustrates a case in which a processing unit receives a producing kernel and a consuming kernel, according to at least one embodiment;

FIG. 7 is a diagram illustrating a case in which an identifier is a virtual address, according to at least one embodiment;

FIG. 8A illustrates an example implementation in which a coordinator is included in a command processor, according to at least one embodiment;

FIG. 8B illustrates an example in which a coordinator is implemented by software, according to at least one embodiment;

FIG. 9 is a flowchart of an operating method of a processing unit, according to at least one embodiment;

FIG. 10 is a diagram illustrating a first processing unit and a second processing unit, according to at least one embodiment;

FIG. 11 is a block diagram illustrating an identifier synchronizer, according to at least one embodiment;

FIG. 12 is a diagram illustrating a case in which an identifier is a virtual address, according to at least one embodiment;

FIG. 13 is a block diagram illustrating an address mapping device according to at least one embodiment;

FIG. 14 is a diagram illustrating a case in which processing devices are a neural processing unit (NPU) and a graphics processing unit (GPU), according to at least one embodiment;

FIG. 15 is a diagram illustrating a case in which processing devices are a GPU and an NPU, according to at least one embodiment;

FIG. 16 is a block diagram of a coordinator according to at least one embodiment;

FIG. 17 is a diagram illustrating a host processor according to at least one embodiment;

FIG. 18 is a diagram illustrating an example in which a host processor includes a command injector, according to at least one embodiment; and

FIG. 19 is a diagram illustrating an example in which a host processor includes a command injector, according to at least one embodiment.

### DETAILED DESCRIPTION OF THE EMBODIMENTS

Hereinafter, embodiments are described in detail with reference to the accompanying drawings. In the drawing, like reference characters denote like elements, and redundant descriptions thereof will be omitted.

Also, in the specification, term like “units”, “driver”, and/or the like, denoting functional elements that are configured to process at least one function or operation may be realized by processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., unless indicated otherwise. The processing circuitry may further include electrical components (such as at least one of transistors, resistors, capacitors, etc.), and/or electronic circuits including said components.

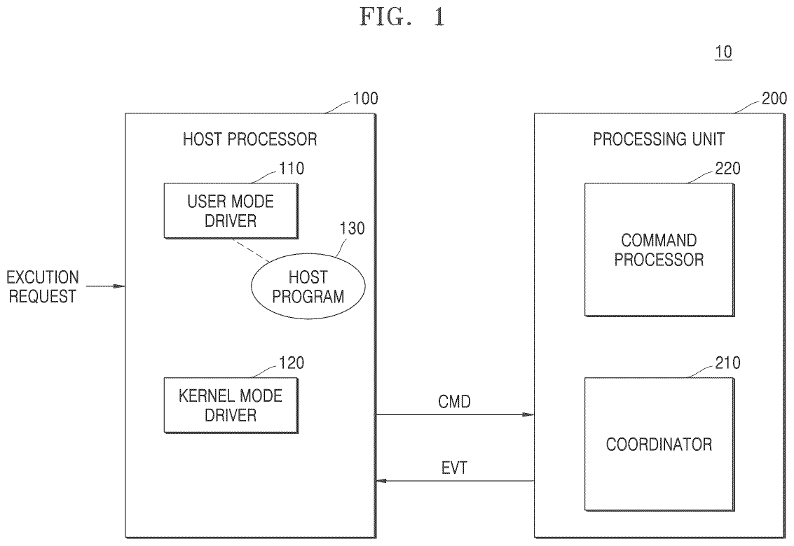

FIG. 1 is a block diagram of an electronic device 10 according to at least one embodiment.

The electronic device 10 is configured to analyze input data in real time, extract valid information based on a neural network, and determine a situation and/or control at least one component of the electronic device 10 based on the extracted valid information. For example, the electronic device 10 may be applied to a drone, an advanced driver assistance system (ADAS), a robot device, a smart television (TV), a smartphone, a medical device, a mobile device, an image display device, a measuring device, an Internet of things (IoT) device, etc., and may be used as various kinds of electronically implemented devices.

For example, as a collection of electrically connected components for processing a series of given instructions or processes, the electronic device 10 may include a computing device. The electronic device 10 may include a system-on-chip (SoC), in which internal parts are implemented in a single chip, or an application processor (AP), which performs processes in a mobile device and/or the like.

The electronic device 10 includes a host processor 100 and a processing unit 200. However, the embodiments are not limited thereto, and the electronic device 10 may further include memory, storage, sensors, etc., according to functional and/or design needs. The host processor 100 may be configured to drive a host program 130. In at least one embodiment, the host processor 100 may include a central processing unit (CPU).

The host processor 100 is configured to generally control the electronic device 10. The host processor 100 may process data in response to the request of a host or a user's input. For example, the host processor 100 may be classified into a complex instruction set computer (CISC) having a complex structure and a reduced instruction set computer (RISC), according to the form of a command set. The CISC may provide various command formats, and the RISC may provide a high operation speed.

The host processor 100 may include a user mode driver 110 and a kernel mode driver 120. The user mode driver 110 may be restricted from (e.g., may not access) important parts (e.g., a kernel address region) of a system but may drive a program (or an application) requested by a host or a user. For example, the user mode driver 110 may drive the host program 130.

The kernel mode driver 120 is configured to drive various programs for processing a neural network. The user mode driver 110 may be configured to execute an application programming interface (API) for neural network processing. The API is a communication protocol defined between an operating system (OS) and an application and may be a rule for accessing a library. The user mode driver 110 may execute the API for neural network processing, thereby accessing a library for the execution of various kernels.

For example, the user mode driver 110 may include an open computing language driver. The open computing language driver may refer to a library for the execution of kernels (such as sub-sampling, convolution, deconvolution, softmax, pooling, normalization, concatenation, quantization, dequantization, ReLu, activation, an arithmetic operation, etc.) for a neural network.

The kernel mode driver 120 may have non-restricted access, and thereby may access all address regions; thus, system reliability needs to be secured. Accordingly, the kernel mode driver 120 may drive only authorized (or signed) programs. The kernel mode driver 120 may manage resources of the processing unit 200. For example, the kernel mode driver 120 may perform functions, such as memory management and context switching, which are similar to the functions of an OS.

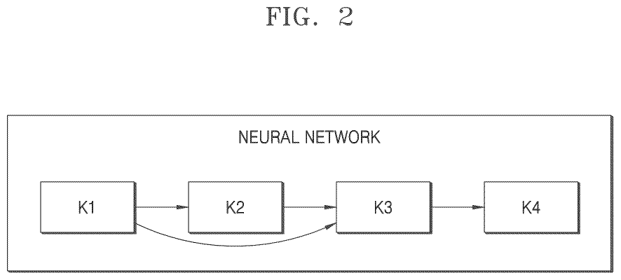

According to a host's or user's neural network processing (execution) request, the host processor 100 may drive an application through the user mode driver 110 and the kernel mode driver 120, access kernels necessary for the requested neural network processing, and issue a plurality of commands CMD including a command for neural network processing. For example, a command CMD may include a kernel command for executing kernels needed to process a neural network and information about types of kernels. However, the embodiments are not limited thereto. The types of kernels may include a producing kernel producing data and a consuming kernel referring to produced data. The types of kernels are described with reference to FIG. 2 below.

The processing unit 200 is configured to process operations related to a neural network. According to at least one embodiment, the processing unit 200 may be configured to perform a parallel operation and to perform a complex matrix operation (for deep learning incorporating neural network technology) relatively quickly. For example, the processing unit 200 may be used as a processor for generating a neural network, training or learning a neural network, and/or performing an operation based on received input data and retraining a neural network.

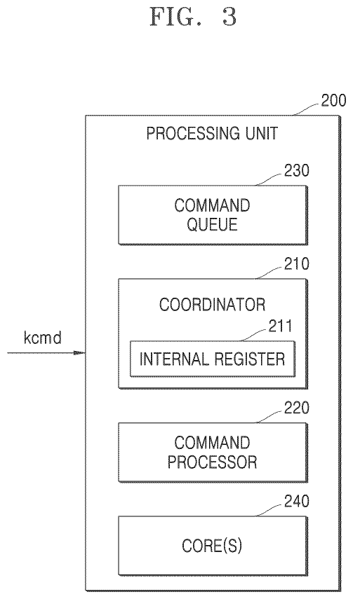

Neural network models may include, but not limited to, various types of models, such as a convolution neural network (CNN) like GoogleNet, AlexNet, or VGG network, a region with CNN (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) network, a classification network, and/or the like. The processing unit 200 may include at least one processing core (e.g., cores 240 in FIG. 3) that performs operations according to neural network models.

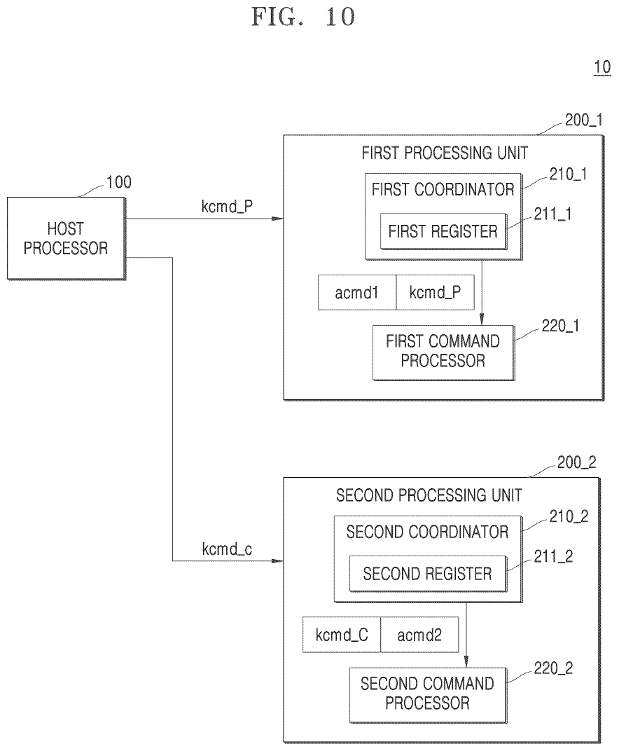

For example, the processing unit 200 may include a graphics processing unit (GPU) processing graphics data, a neural processing unit (NPU) for internal operations of a neural network, a digital signal processor (DSP), and an image signal processor (ISP). Although it is illustrated in FIG. 1 that the electronic device 10 includes one processing unit 200, the embodiments are not limited thereto. The electronic device 10 may include two or more processing units 200. For example, the electronic device 10 may include a first GPU and a second GPU. The electronic device 10 may include different kinds of processing units 200. For example, the electronic device 10 may include an NPU and a GPU. The electronic device 10 including a plurality of processing units 200 is described with reference to FIG. 10 below.

The processing unit 200 may include a coordinator 210 and a command processor 220. However, the embodiments are not limited thereto. For example, the processing unit 200 may further include components to process operations related to a neural network according to the functional and/or design needs. For example, when the processing unit 200 is a GPU, the GPU may include a dispatcher configured to schedule commands received from the host processor 100 to operation cores, a vertex fetcher for geometry processing, and a vertex shading operation unit. However, the embodiments are not limited thereto.

The coordinator 210 is configured to determine the type of kernel corresponding to a kernel command. The coordinator 210 may receive a kernel command from the host processor 100 and determine the type of kernel corresponding to the kernel command. For example, the coordinator 210 may receive at least one of a producing kernel command and a consuming kernel command. The producing kernel command may correspond to a producing kernel and may request to execute the producing kernel. When receiving the producing kernel command, the processing unit 200 may execute the producing kernel. The consuming kernel command may correspond to a consuming kernel and may request to execute the consuming kernel. When receiving the consuming kernel command, the processing unit 200 may execute the consuming kernel.

When receiving the producing kernel command, the coordinator 210 may determine the type of kernel to be the producing kernel. When receiving the consuming kernel command, the coordinator 210 may determine the type of kernel to be the consuming kernel.

In at least one embodiment, the coordinator 210 may generate an additional command according to the type of kernel. The coordinator 210 may generate different additional commands according to types of kernels. In other words, the coordinator 210 may generate different additional commands according to types of kernel commands. The coordinator 210 may generate an additional command to allow a consuming kernel to be executed by referring to data produced by a producing kernel.

For example, when receiving a producing kernel command, the coordinator 210 may generate a first additional command in correspondence to the producing kernel command. When receiving a consuming kernel command, the coordinator 210 may generate a second additional command in correspondence to the consuming kernel command. The first additional command may request to write an identifier corresponding to the producing kernel command to an internal register of the processing unit 200. The identifier corresponding to the producing kernel command may indicate that execution of the producing kernel command has completed. When the execution of the producing kernel command has completed, the identifier corresponding to the producing kernel command may be written to the internal register of the processing unit 200.

The second additional command may be a request to wait until an identifier corresponding to the consuming kernel command is written to an internal register of the processing unit 200. When the identifier corresponding to the consuming kernel command has been written to the internal register of the processing unit 200, the consuming kernel command may be executed. The identifier corresponding to the consuming kernel command may indicate that execution of the consuming kernel command is possible. Operations of the coordinator 210 are described in detail with reference to FIG. 3 below.

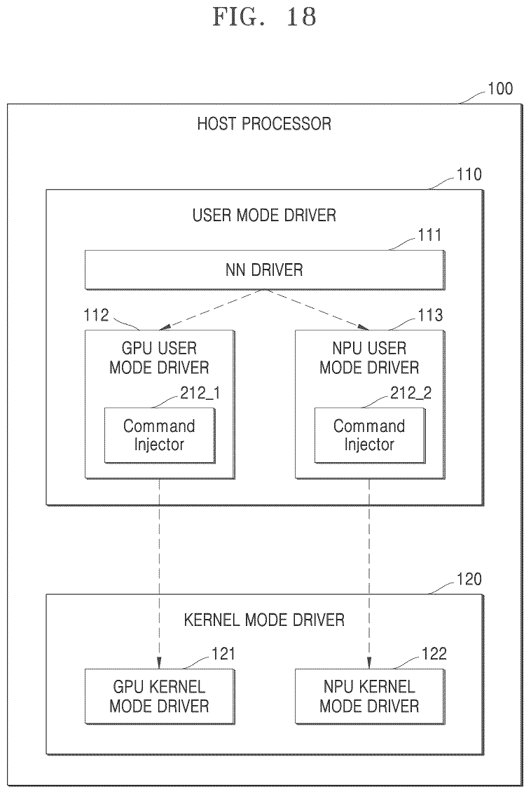

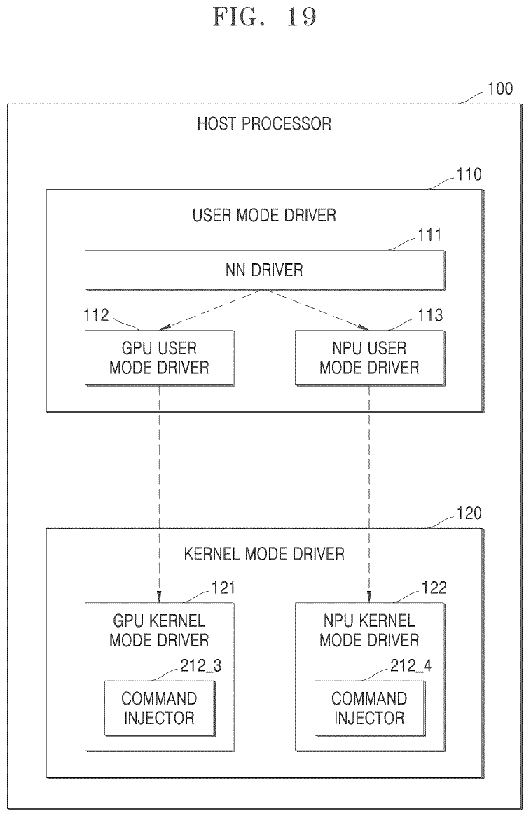

Although it is illustrated in FIG. 1 that the coordinator 210 is included in the processing unit 200, embodiments are not limited thereto. In at least one embodiment, some of the functions of the coordinator 210 may be performed by the host processor 100. For example, one of the user mode driver 110 and the kernel mode driver 120 may generate an additional command according to the type of kernel. This is described with reference to FIGS. 18 and 19 below.

The command processor 220 is configured to receive and process the commands CMD. The command processor 220 may schedule such that data produced by a producing kernel is referred to when a consuming kernel is executed based on a kernel command and an additional command. The processing unit 200 may receive a producing kernel command and generate the producing kernel, based on the producing kernel command and the first additional command. The command processor 220 may schedule the first additional command to be executed after the producing kernel is executed.

For example, a core of the command processor 220 may execute the producing kernel command and the first additional command and may write an identifier corresponding to the producing kernel command to an internal register of the processing unit 200 by executing the first additional command. When the producing kernel is executed based on the producing kernel command, data may be stored in memory outside the processing unit 200. When the data is stored in the memory, the identifier corresponding to the producing kernel command may be written to the internal register of the processing unit 200.

For example, a core of the processing unit 200 may execute the consuming kernel command and the second additional command. When the identifier corresponding to the consuming kernel command is written to an internal register of the processing unit 200 by executing the second additional command, the processing unit 200 may execute the consuming kernel command. When the identifier corresponding to the consuming kernel command has been written to the internal register of the processing unit 200, the processing unit 200 may recognize that execution of the producing kernel has been completed, and the second additional command requesting to periodically check until the identifier corresponding to the consuming kernel command is written to the internal register of the processing unit 200 may be terminated. When the second additional command is terminated, the processing unit 200 may execute the consuming kernel by referring to a result of executing the producing kernel, based on the consuming kernel command. The processing unit 200 may execute the consuming kernel by referring to data corresponding to the result of executing the producing kernel.

The processing unit 200 may receive a producing kernel command and a consuming kernel command. A core of the processing unit 200 may execute the producing kernel command, a first additional command, the consuming kernel command, and a second additional command. In at least one embodiment, an identifier corresponding to the producing kernel command may be the same as an identifier corresponding to the consuming kernel command.

When one processing unit 200 receives a producing kernel command and a consuming kernel command, the processing unit 200 may execute the producing kernel command, may then write an identifier corresponding to the producing kernel command to an internal register thereof by executing a first additional command, may confirm that an identifier corresponding to the consuming kernel command, which is the same as (or substantially similar to) the identifier corresponding to the producing kernel command, has been written to the internal register based on a second additional command, and may execute the consuming kernel command.

The processing unit 200 may execute kernels applicable to the neural network processing and may schedule input/output between kernels. For example, when a current kernel is the last one, the processing unit 200 may output, to the host processor 100, an event EVT indicating a neural network processing result.

When interactions (e.g., transfer of a kernel execution result and produced data) occur between the host processor 100 and the processing unit 200 for the connection between a producing kernel and a consuming kernel whenever a kernel is executed, a kernel execution time may increase. Given the technological trend in machine learning, which includes an increasing number of kernel executions, this may cause a decrease in neural network processing speed. Furthermore, when interactions between the host processor 100 and the processing unit 200 occur at execution of each of all kernels, the host processor 100 may unnecessarily consume standby power and/or unnecessarily occupy resources.

According to the inventive concepts, the electronic device 10 may generate a first additional command and a second additional command according to a kernel command and allow a consuming kernel to refer to data produced by a producing kernel, based on the first additional command and the second additional command, so that the data produced by the producing kernel may be referred to at the execution of the consuming kernel, even without interactions between the host processor 100 and the processing unit 200. Accordingly, interactions between the host processor 100 and the processing unit 200 may be reduced, neural network processing speed may be increased, and power consumption of the host processor 100 may be decreased.

FIG. 2 is a diagram illustrating kernels according to at least one embodiment.

Referring to FIG. 2, a neural network may include a plurality of kernels. For example, the neural network may include four kernels. However, this is just an example to explain a kernel, and the embodiments are not limited thereto. A neural network may include various numbers of kernels. Connection relationships among kernels of a neural network in FIG. 2 are assumed for convenience of descriptions. Connection relationships among kernels are not limited to those shown in FIG. 2.

Types of kernels may include a producing kernel that produces data and a consuming kernel that refers to the produced data. An execution result of a first kernel K1 may be provided as an input of a second kernel K2 and an input of a third kernel K3. In the relationship between the first kernel K1 and the second kernel K2, the first kernel K1 may correspond to a producing kernel because the first kernel K1 produces execution result data and the second kernel K2 may correspond to a consuming kernel because the second kernel K2 refers to the data of the first kernel K1.

An execution result of the second kernel K2 may be provided to an input of the third kernel K3. In the relationship between the second kernel K2 and the third kernel K3, the second kernel K2 may correspond to a producing kernel and the third kernel K3 may correspond to a consuming kernel.

To execute the third kernel K3, both the output of the second kernel K2 and the output of the first kernel K1 may be provided. In relationships among the first kernel K1, the second kernel K2, and the third kernel K3, the first kernel K1 and the second kernel K2 may each correspond to a producing kernel and the third kernel K3 may correspond to a consuming kernel.

In the relationship between the third kernel K3 and a fourth kernel K4, the third kernel K3 may correspond to a producing kernel and the fourth kernel K4 may correspond to a consuming kernel.

Referring to FIG. 1 and FIG. 2, the host processor 100 may determine the processing unit 200 that executes a kernel. The host processor 100 may generate a command for allowing the determined processing unit 200 to execute the kernel. The host processor 100 may generate a producing kernel command for allowing the processing unit 200 to execute a producing kernel. For example, the host processor 100 may generate a producing kernel command for the first kernel K1 so that the first kernel K1 is executed as a producing kernel. The host processor 100 may generate a consuming kernel command for allowing the processing unit 200 to execute a consuming kernel. For example, the host processor 100 may generate a consuming kernel command for the second kernel K2 so that the second kernel K2 is executed as a consuming kernel.

FIG. 3 is a block diagram illustrating a processing unit according to at least one embodiment. The processing unit 200, the coordinator 210, and the command processor 220 in FIG. 3 respectively correspond to the processing unit 200, the coordinator 210, and the command processor 220 in FIG. 1, and thus, redundant descriptions thereof may be omitted below.

Referring to FIG. 3, the processing unit 200 may further include a command queue 230, the coordinator 210, the command processor 220, and a core 240. The processing unit 200 may receive a command from a host processor (e.g., the host processor 100 in FIG. 1). For example, the processing unit 200 may receive a kernel command kcmd from the host processor 100. The processing unit 200 may receive the kernel command kcmd for executing kernels required to process a neural network.

Commands received by the processing unit 200 may be stored in the command queue 230. For example, the processing unit 200 may store the kernel command kcmd in the command queue 230. For example, the kernel command kcmd may be stored in the command queue 230, based on dependency on kernel command(kcmd)s, the execution order, etc. The kernel command kcmd may be executed according to the dependency on other kernel commands and the execution order.

The coordinator 210 may be configured to determine the type of kernel corresponding to the kernel command kcmd and may generate an additional command according to the type of kernel. The coordinator 210 may determine the type of kernel corresponding to a kernel command. For example, when receiving a producing kernel command requesting to execute a producing kernel, the coordinator 210 may determine that a kernel corresponding to the producing kernel command is a producing kernel. In other words, the coordinator 210 may receive a producing kernel command and determine that the type of kernel command kcmd is a producing kernel command. For example, when receiving a consuming kernel command requesting to execute a consuming kernel, the coordinator 210 may determine that a kernel corresponding to the consuming kernel command is a consuming kernel. In other words, the coordinator 210 may receive a consuming kernel command and determine that the type of kernel command kcmd is a consuming kernel command.

In at least one embodiment, the coordinator 210 may generate an additional command according to the type of kernel. The coordinator 210 may monitor the command queue 230 and generate an additional command based on the kernel command kcmd stored in the command queue 230. In at least one embodiment, the coordinator 210 may generate an additional command and store the additional command in the command queue 230. The command queue 230 may be updated.

The coordinator 210 may be configured to generate different additional commands based on the type of kernel. For example, the coordinator 210 may generate an additional command according to the type of kernel corresponding to the kernel command kcmd that has been received. In other words, the coordinator 210 may generate a different additional command according to the type of kernel command. The coordinator 210 may generate an additional command for allowing a consuming kernel to be executed by referring to data produced by a producing kernel.

In at least one embodiment, when receiving a producing kernel command, the coordinator 210 may generate a first additional command. When the producing kernel command is stored in the command queue 230, the coordinator 210 may determine that the type of kernel corresponding to the producing kernel command is a producing kernel and may generate the first additional command. The coordinator 210 may generate the first additional command because the type of kernel command kcmd is a producing kernel command. The first additional command may request to write an identifier corresponding to the producing kernel command to an internal register 211 of the coordinator 210.

In at least one embodiment, when receiving a consuming kernel command, the coordinator 210 may generate a second additional command. When the consuming kernel command is stored in the command queue 230, the coordinator 210 may determine that the type of kernel corresponding to the consuming kernel command is a consuming kernel and may generate the second additional command. For example, the coordinator 210 may generate the second additional command in response to a determination that the type of kernel command kcmd is a consuming kernel command. The second additional command may request to periodically check until an identifier corresponding to the consuming kernel command is written to the internal register 211 of the coordinator 210.

The coordinator 210 may store an identifier. In at least one embodiment, the coordinator 210 may include the internal register 211 that stores an identifier. The internal register 211 may store at least one of an identifier corresponding to a producing kernel command and an identifier corresponding to a consuming kernel command. Although it is illustrated in FIG. 3 that the internal register 211 storing an identifier is included in the coordinator 210, embodiments are not limited thereto. The internal register 211 may be included in the processing unit 200 and may be outside the coordinator 210.

The command processor 220 may be configured to process the kernel command kcmd. For example, the command processor 220 may interpret the kernel command kcmd and may schedule the kernel command kcmd, based on dependencies between kernel commands kcmd. The command processor 220 may schedule a kernel command and an additional command such that data produced by a producing kernel is referred to when a consuming kernel is executed. For example, the command processor 220 may schedule an additional command and the kernel command kcmd, which has been stored in the command queue 230. The command processor 220 may schedule the kernel command kcmd and the additional command such that the core 240 performs operations based on the kernel command kcmd and the additional command. For example, the command processor 220 may schedule a first additional command to be executed after a producing kernel command is executed. For example, the command processor 220 may schedule a second additional command to be executed before a consuming kernel command is executed.

The core 240 may be configured to perform various operations. For example, the core 240 may perform an operation according to a neural network. The core 240 may execute kernels. The processing unit 200 may include a single core 240 or multiple cores 240. The core 240 may perform operations based on commands received from the host processor 100.

The core 240 may perform an operation based on the kernel command kcmd and an additional command. The core 240 may execute a kernel based on the kernel command kcmd and perform an operation corresponding to the additional command, based on the additional command. The core 240 may execute a producing kernel, based on a producing kernel command and a first additional command. For example, the core 240 may execute the producing kernel based on the producing kernel command and write an identifier corresponding to the producing kernel command to the internal register 211, based on the first additional command.

The core 240 may execute a consuming kernel, based on a consuming kernel command and a second additional command. For example, based on the second additional command, the core 240 may wait until an identifier corresponding to the consuming kernel command is written to the internal register 211. The core 240 may periodically check, based on the second additional command, whether the identifier corresponding to the consuming kernel command is written to the internal register 211 and may not execute the consuming kernel command the identifier has been determined to have not been written to the internal register 211. When the identifier has been determined to have been written to the internal register 211, based on the second additional command, the core 240 may terminate the execution of the second additional command and may execute a consuming kernel based on the consuming kernel command following the second additional command.

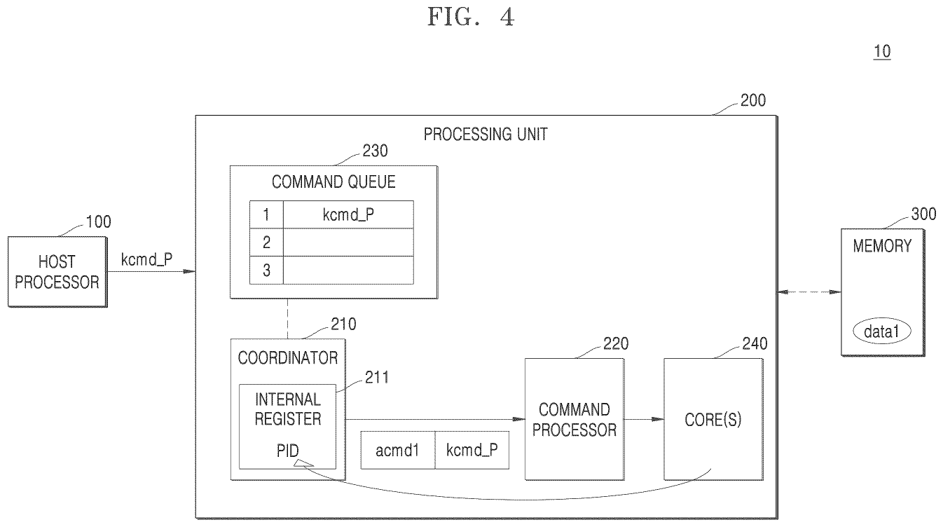

FIG. 4 is a diagram illustrating a first additional command according to at least one embodiment. FIG. 4 illustrates a case in which the processing unit 200 receives a producing kernel command kcmd_P. Redundant descriptions given above may be omitted below.

Referring to FIG. 4, the electronic device 10 may include the host processor 100, the processing unit 200, and a memory 300. The host processor 100 may transmit a kernel command (e.g., the kernel command kcmd in FIG. 3) to the processing unit 200. The host processor 100 may identify the type of kernel, determine the processing unit 200 that executes the kernel, and transmit the kernel command kcmd to allow the determined processing unit 200 to execute the kernel.

In at least one embodiment, the host processor 100 may transmit the producing kernel command kcmd_P to the processing unit 200. For example, referring to FIGS. 1, 2, and 4, the host processor 100 may transmit the producing kernel command kcmd_P for the first kernel K1 such that the first kernel K1 is executed as a producing kernel. For example, the host processor 100 may transmit the producing kernel command kcmd_P for the second kernel K2 such that the second kernel K2 is executed as a producing kernel.

The processing unit 200 may receive the kernel command kcmd from the host processor 100. For example, the processing unit 200 may receive the producing kernel command kcmd_P from the host processor 100. The processing unit 200 may execute a producing kernel based on the producing kernel command kcmd_P. Because the processing unit 200 receives the producing kernel command kcmd_P, the processing unit 200 may act as a producer. A producer may refer to the processing unit 200 that writes data to the memory 300 and may otherwise be referred to as a master, leader, a server, and/or the like. Here, as a producer, the processing unit 200 may be referred to as a first processing unit (e.g., a first processing unit 200_1 in FIG. 10). In at least one embodiment, the processing unit 200 may correspond to a GPU. However, embodiments are not limited thereto. The processing unit 200 may correspond to an NPU, a DSP, an ISP, etc.

The producing kernel command kcmd_P may be stored in the command queue 230. The coordinator 210 may determine the type of kernel corresponding to the kernel command kcmd and generate an additional command according to the type of kernel. The coordinator 210 may determine that a kernel corresponding to the producing kernel command kcmd_P is a producing kernel.

The coordinator 210 may generate a first additional command acmd1 corresponding to the producing kernel command kcmd_P. The first additional command acmd1 may request to write an identifier corresponding to the producing kernel command kcmd_P to the internal register 211 of the coordinator 210. In at least one embodiment, the coordinator 210 may add the first additional command acmd1 behind the producing kernel command kcmd_P to follow the producing kernel command kcmd_P. For example, the coordinator 210 may update the command queue 230 such that the first additional command acmd1 comes next after the producing kernel command kcmd_P in a queue. The first additional command acmd1 may be executed after the producing kernel command kcmd_P is executed.

The command processor 220 may schedule the kernel command kcmd and an additional command so that the core 240 may perform operations. The command processor 220 may schedule the first additional command acmd1 to be executed after the producing kernel command kcmd_P is executed. The command processor 220 may schedule such that the core 240 executes an operation corresponding to the first additional command acmd1, based on the first additional command acmd1, after executing a producing kernel based on the producing kernel command kcmd_P.

The core 240 may be configured to execute a producing kernel, based on the producing kernel command kcmd_P and the first additional command acmd1. The core 240 may execute a producing kernel based on the producing kernel command kcmd_P. The core 240 may store, in the memory 300, a result of executing the producing kernel based on the producing kernel command kcmd_P. First data data1 produced as the result of executing the producing kernel may be stored in the memory 300. For example, referring to FIGS. 2 and 4, the first kernel K1 that is a producing kernel may be executed, and the first data data1 may be stored in the memory 300. For example, the second kernel K2 that is a producing kernel may be executed, and the first data data1 may be stored in the memory 300.

When a result of executing a kernel is stored in the memory 300, the core 240 may execute the first additional command acmd1. When a result of executing a producing kernel is stored in the memory 300, the core 240 may perform an operation corresponding to the first additional command acmd1. When the first data data1 is stored in the memory 300, the core 240 may write an identifier PID corresponding to the producing kernel command kcmd_P to the internal register 211, based on the first additional command acmd1. For example, the identifier PID corresponding to the producing kernel command kcmd_P of each producing kernel may be different. For example, referring to FIGS. 2 and 4, the identifier PID corresponding to the producing kernel command kcmd_P of the first kernel K1 that is a producing kernel may be different from the identifier PID corresponding to the producing kernel command kcmd_P of the second kernel K2 that is a producing kernel. Accordingly, which of the producing kernel corresponds to the identifier PID may be identified.

The memory 300 may store a result of executing a producing kernel. For example, the memory 300 may store the first data data1. In at least one embodiment, the memory 300 may include a shared memory. The host processor 100 and the processing unit 200 may share the memory 300. When a plurality of processing units 200 are included in the electronic device 10, the processing units 200 may share the memory 300. A virtual address corresponding to the processing unit 200 may be transmitted from the host processor 100 to the processing unit 200. The virtual address may be an address that the processing unit 200 refers to during a process and may correspond to a real physical address.

The processing unit 200 may store an execution result of a producing kernel in a memory region corresponding to the virtual address in the memory 300. A virtual address corresponding to the same physical address may be different according to the type of processing unit 200. For example, when the processing unit 200 is a GPU, the GPU may store an execution result of a producing kernel in a memory region corresponding to a GPU virtual address. When the processing unit 200 is an NPU, the NPU may store an execution result of a producing kernel in a memory region corresponding to an NPU virtual address.

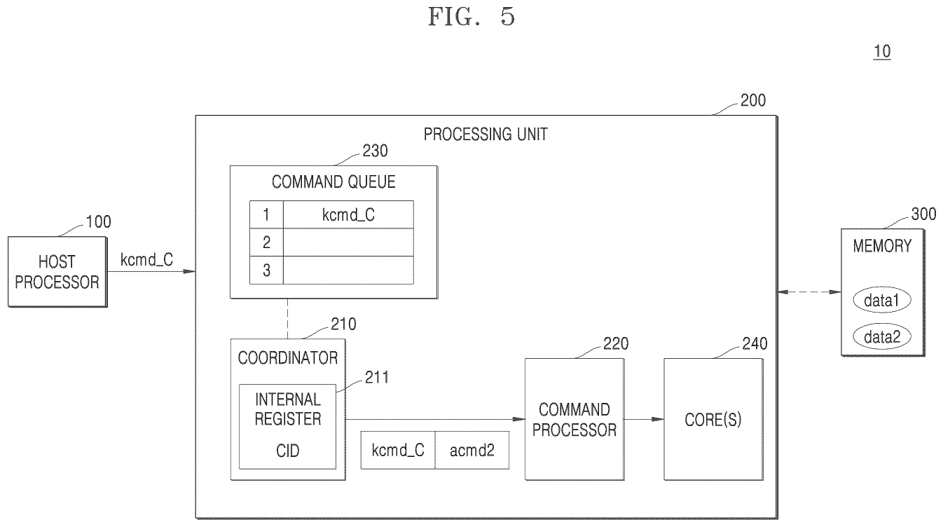

FIG. 5 is a diagram illustrating a second additional command according to at least one embodiment. FIG. 5 illustrates a case in which the processing unit 200 receives a consuming kernel command kcmd_C. Redundant descriptions given above with reference to FIG. 4 may be omitted below.

The host processor 100 may transmit the consuming kernel command kcmd_C to the processing unit 200. For example, referring to FIGS. 1, 2, and 4, the host processor 100 may transmit the consuming kernel command kcmd_C for the second kernel K2 such that the second kernel K2 is executed as a consuming kernel with respect to the first kernel K1. For example, the host processor 100 may transmit the consuming kernel command kcmd_C for the third kernel K3 such that the third kernel K3 is executed as a consuming kernel with respect to the second kernel K2.

The processing unit 200 may receive the consuming kernel command kcmd_C from the host processor 100. The processing unit 200 may execute a consuming kernel based on the consuming kernel command kcmd_C. Because the processing unit 200 receives the consuming kernel command kcmd_C, the processing unit 200 may act as a consumer. A consumer may refer to the processing unit 200 that reads data from the memory 300 and may also be referred to as a slave, a follower, a client, and/or the like. Here, as a consumer, the processing unit 200 may be referred to as a second processing unit (e.g., a second processing unit 200_2 in FIG. 10).

The consuming kernel command kcmd_C may be stored in the command queue 230. The coordinator 210 may determine that a kernel corresponding to the consuming kernel command kcmd_C is a consuming kernel. The coordinator 210 may receive the consuming kernel command kcmd_C and generate a second additional command acmd2 corresponding to the consuming kernel command kcmd_C. The second additional command acmd2 may request to wait until an identifier corresponding to the consuming kernel command kcmd_C is written to the internal register 211.

In at least one embodiment, the coordinator 210 may add the second additional command acmd2 before the consuming kernel command kcmd_C to precede the consuming kernel command kcmd_C. For example, the coordinator 210 may update the command queue 230 such that the second additional command acmd2 comes before the consuming kernel command kcmd_C in a queue. The consuming kernel command kcmd_C may be executed after the second additional command acmd2 is executed.

The command processor 220 may schedule the second additional command acmd2 to be executed before the consuming kernel command kcmd_C is executed. The command processor 220 may schedule such that the core 240 executes a consuming kernel, based on the consuming kernel command kcmd_C, after executing an operation corresponding to the second additional command acmd2, based on the second additional command acmd2.

The core 240 may execute a consuming kernel, based on the consuming kernel command kcmd_C and the second additional command acmd2. The core 240 may execute the second additional command acmd2. The core 240 may check, based on the second additional command acmd2, whether an identifier CID corresponding to the consuming kernel command kcmd_C is written to the internal register 211. When the identifier CID has been confirmed as having been written to the internal register 211, the core 240 may execute the consuming kernel based on the consuming kernel command kcmd_C. When the identifier CID corresponding to the consuming kernel command kcmd_C is written to the internal register 211, it may mean that a producing kernel is completely executed. Then, the core 240 may execute the consuming kernel by referring to an execution result of the producing kernel.

For example, the identifier CID corresponding to the consuming kernel command kcmd_C of each consuming kernel may be different. For example, referring to FIGS. 2 and 4, the identifier CID corresponding to the consuming kernel command kcmd_C of the second kernel K2 that is a consuming kernel may be different from the identifier CID corresponding to the consuming kernel command kcmd_C of the third kernel K3 that is a consuming kernel. Accordingly, it may be identified which consuming kernel corresponds to the identifier CID.

Based on the consuming kernel command kcmd_C, the core 240 may execute a consuming kernel by referring to a producing kernel execution result stored in the memory 300. The core 240 may read the producing kernel execution result from a memory region corresponding to a virtual address in the memory 300 and may use the producing kernel execution result when executing the consuming kernel. For example, the core 240 may execute the consuming kernel by referring to the first data data1 stored in the memory 300. For example, referring to FIGS. 2 and 4, when executing the second kernel K2 that is a consuming kernel with respect to the first kernel K1 that is a producing kernel, the core 240 may read the first data data1 that is the execution result of the first kernel K1 from the memory 300 and may refer to the first data data1.

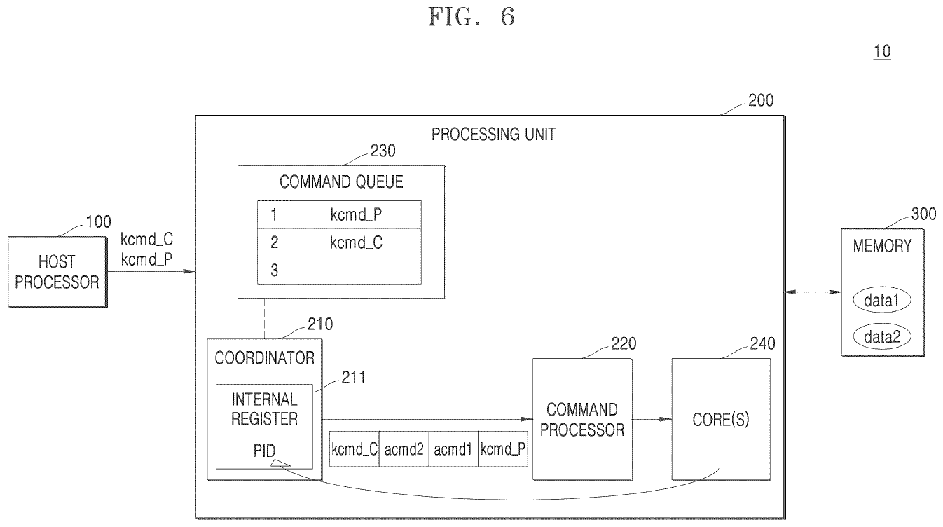

In at least one embodiment, the identifier CID corresponding to the consuming kernel command kcmd_C may be the same as (and/or substantially similar to) an identifier (e.g., the identifier PID in FIG. 4) corresponding to a producing kernel command (e.g., the producing kernel command kcmd_P in FIG. 4). However, the embodiments are not limited thereto. The identifier CID corresponding to the consuming kernel command kcmd_C may be different from an identifier corresponding to a producing kernel command. A case where the identifier CID corresponding to the consuming kernel command kcmd_C is the same as the identifier PID corresponding to the producing kernel command kcmd_P is described with reference to FIG. 6 below.

FIG. 6 illustrates a case in which a processing unit receives a producing kernel and a consuming kernel, according to at least one embodiment. Redundant descriptions given above may be omitted below.

Referring to FIG. 6, the host processor 100 may transmit the producing kernel command kcmd_P and the consuming kernel command kcmd_C to the processing unit 200. The processing unit 200 may receive the producing kernel command kcmd_P and the consuming kernel command kcmd_C corresponding to the producing kernel command kcmd_P. For example, referring to FIG. 2, the processing unit 200 may receive the producing kernel command kcmd_P for the first kernel K1 that is a producing kernel and the consuming kernel command kcmd_C for the second kernel K2 that is a consuming kernel. Because the processing unit 200 receives the producing kernel command kcmd_P and the consuming kernel command kcmd_C, the processing unit 200 may act as a producer and a consumer. The processing unit 200 may act as a producer when executing the producing kernel command kcmd_P and may act as a consumer when executing the consuming kernel command kcmd_C.

The producing kernel command kcmd_P and the consuming kernel command kcmd_C may be stored in the command queue 230. The coordinator 210 may determine that a kernel corresponding to the producing kernel command kcmd_P is a producing kernel and may generate the first additional command acmd1. The coordinator 210 may determine that a kernel corresponding to the consuming kernel command kcmd_C is a consuming kernel and may generate the second additional command acmd2.

In at least one embodiment, the coordinator 210 may add the first additional command acmd1 behind the producing kernel command kcmd_P to follow the producing kernel command kcmd_P. The coordinator 210 may add the second additional command acmd2 before the consuming kernel command kcmd_C to precede the consuming kernel command kcmd_C. For example, the coordinator 210 may update the command queue 230 such that the first additional command acmd1 comes next after the producing kernel command kcmd_P and the second additional command acmd2 comes before the consuming kernel command kcmd_C in a queue.

The command processor 220 may schedule the producing kernel command kcmd_P, the first additional command acmd1, the second additional command acmd2, and the consuming kernel command kcmd_C to be executed in order. The command processor 220 may schedule such that the core 240 performs, based on the second additional command acmd2, an operation corresponding to the second additional command acmd2 after performing, based on the first additional command acmd1, an operation corresponding to the first additional command acmd1.

The core 240 may execute a producing kernel based on the producing kernel command kcmd_P. The first data data1 that is produced as a result of executing the producing kernel may be stored in the memory 300. For example, referring to FIGS. 1, 2, and 4, the first kernel K1 that is a producing kernel may be executed, and the first data data1 may be stored in the memory 300.

When a kernel execution result is stored in the memory 300, the core 240 may execute the first additional command acmd1. When the first data data1 is stored in the memory 300, the core 240 may write the identifier PID corresponding to the producing kernel command kcmd_P to the internal register 211, based on the first additional command acmd1. For example, when the first data1 is stored in the memory 300 after the first kernel K1 is completely executed, the identifier PID corresponding to the producing kernel command kcmd_P for the first kernel K1 may be written to the internal register 211. The identifier PID may indicate that execution of a producing kernel command has been completed and may identify a specific kernel. For example, the identifier PID may include a virtual address but is not limited thereto.

The core 240 may execute the second additional command acmd2. The core 240 may check, based on the second additional command acmd2, whether the identifier CID corresponding to the consuming kernel command kcmd_C is written to the internal register 211, may terminate the execution of the second additional command acmd2 when the identifier CID has been written to the internal register 211, and may then execute a consuming kernel based on the consuming kernel command kcmd_C.

In at least one embodiment, the identifier PID corresponding to the producing kernel command kcmd_P may be the same as (and/or substantially similar to) an identifier (e.g., the identifier CID in FIG. 5) corresponding to the consuming kernel command kcmd_C. Because the identifier PID corresponding to the producing kernel command kcmd_P is the same as the identifier CID corresponding to the consuming kernel command kcmd_C, writing the identifier PID corresponding to the producing kernel command kcmd_P to the internal register 211 may be the same as writing the identifier CID corresponding to the consuming kernel command kcmd_C to the internal register 211.

Because the identifier PID has been written to the internal register 211 based on the first additional command acmd1, the core 240 may determine based on the second additional command acmd2 that the identifier corresponding to the consuming kernel command kcmd_C has been written to the internal register 211 and may execute a consuming kernel based on the consuming kernel command kcmd_C. Based on the first additional command acmd1 and the second additional command acmd2, the core 240 may execute the consuming kernel by referring to the execution result of the producing kernel. The core 240 may execute the consuming kernel by referring to the first data data1 stored in the memory 300. For example, the core 240 may execute the second kernel K2 by referring to the first data data1 that is the execution result of the first kernel K1.

Second data data2 that is produced as a result of executing the consuming kernel may be stored in the memory 300. For example, the first data data1 and the second data data2 may be stored in different regions of the memory 300. Referring to FIG. 6, when a kernel corresponding to the consuming kernel command kcmd_C is executed as a producing kernel, a consuming kernel corresponding to the producing kernel may be executed by referring to the second data data2 stored in the memory 300. For example, the core 240 may execute the second kernel K2 by referring to the first data data1 that is the execution result of the first kernel K1 and may store, in the memory 300, the second data data2 that is an execution result of the second kernel K2. The core 240 may execute the third kernel K3 by referring to the second data data2.

According to the inventive concepts, the electronic device 10 may be configured to generate the first additional command acmd1 in correspondence to the producing kernel command kcmd_P and the second additional command acmd2 in correspondence to the consuming kernel command kcmd_C. Based on the first additional command acmd1 and the second additional command acmd2, which are generated by the processing unit 200, the processing unit 200 may execute a consuming kernel by referring to data (e.g., the first data data1) produced by a producing kernel. The producing kernel may be referred to when the consuming kernel is executed even without interactions between the host processor 100 and the processing unit 200, and accordingly, interactions between the host processor 100 and the processing unit 200 may be reduced. As a result, neural network processing speed may be increased, and power consumption of the host processor 100 may be decreased.

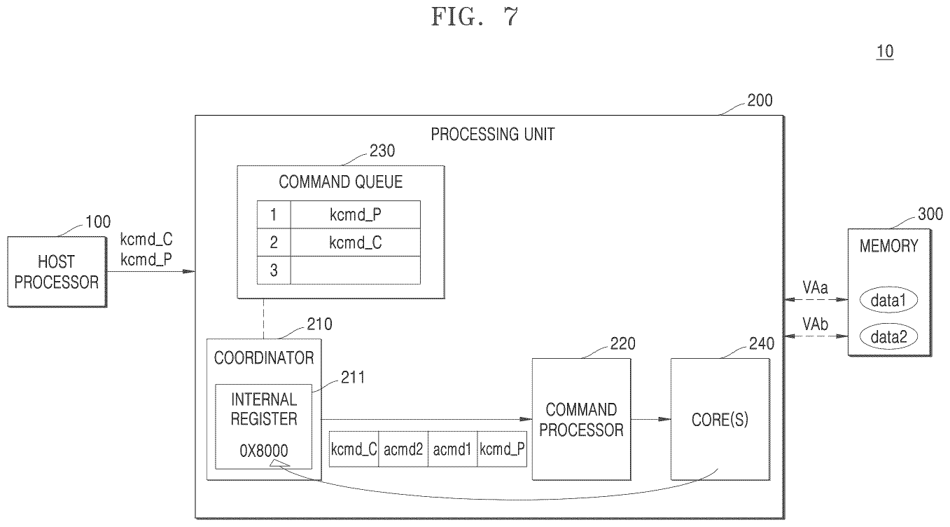

FIG. 7 is a diagram illustrating a case in which an identifier is a virtual address, according to at least one embodiment. Redundant descriptions given above may be omitted below.

Referring to FIG. 7, the host processor 100 may transmit the producing kernel command kcmd_P and the consuming kernel command kcmd_C to the processing unit 200. The processing unit 200 may receive the producing kernel command kcmd_P and the consuming kernel command kcmd_C corresponding to the producing kernel command kcmd_P.

The core 240 may execute a producing kernel based on the producing kernel command kcmd_P. A virtual address corresponding to the producing kernel command kcmd_P may be transmitted from the host processor 100 to the processing unit 200. The virtual address may be determined based on the type of processing unit 200 and a kernel indicated by a kernel command. For example, the processing unit 200 may receive the producing kernel command kcmd_P and a virtual address VAa. The first data data1 may be stored in a memory region of the memory 300, which is indicated by the virtual address VAa.

The processing unit 200 may receive a virtual address in correspondence to a kernel command for each kernel. A virtual address corresponding to a kernel command may include a virtual address, to which data of a kernel that is referred to by each kernel is written, and a virtual address, to which data produced by each kernel is written. For example, referring to FIG. 2 together, it may be assumed that the first kernel K1 is a producing kernel and the second kernel K2 is a consuming kernel. The processing unit 200 may receive the producing kernel command kcmd_P for the first kernel K1 and the virtual address VAa, to which the first data data1 produced by the first kernel K1 is written. The core 240 may execute the producing kernel command kcmd_P for the first kernel K1 and may store the first data data1 in a position in the memory 300, which is indicated by the virtual address VAa. The processing unit 200 may receive the producing kernel command kcmd_P for the second kernel K2, the virtual address VAa to which data referred to by the second kernel K2 has been written, and a virtual address VAb to which the second data data2 produced by the second kernel K2 is written. The core 240 may execute the second kernel K2 by referring to the first data data1 stored in the position in the memory 300, which is indicated by the virtual address VAa, and may store the second data data2, which is produced by executing the second kernel K2, in a position in the memory 300, which is indicated by the virtual address VAb.

When the first data data1 is stored in the memory 300, the core 240 may write the identifier PID corresponding to the producing kernel command kcmd_P to the internal register 211, based on the first additional command acmd1. In at least one embodiment, the identifier PID corresponding to the producing kernel command kcmd_P may include a virtual address indicating a position in the memory 300, in which data produced by a producing kernel. For example, the virtual address VAa indicating the position in which the first data data1 is stored may be written to the internal register 211. When the producing kernel command kcmd_P for the first kernel K1 is executed and the first data data1 is stored in the position indicated by the virtual address VAa in the memory 300, the virtual address VAa may be stored in the internal register 211, based on the first additional command acmd1. For example, 0X8000, as the virtual address VAa, may be written to the internal register 211. However, 0X8000 is just an example of a virtual address, and embodiments are not limited thereto.

In at least one embodiment, an identifier corresponding to the producing kernel command kcmd_P may be the same as an identifier corresponding to the consuming kernel command kcmd_C. A virtual address, to which data produced by a producing kernel is written, may be the same as a virtual address, to which data referred to by a consuming kernel has been written. The same processing unit 200 may access memory by using the same virtual address system. For example, when the processing unit 200 corresponds to a GPU, the GPU may access the memory 300 by using a GPU virtual address. When the processing unit 200 corresponds to an NPU, the NPU may access the memory 300 by using an NPU virtual address. Because an operation corresponding to the producing kernel command kcmd_P and an operation corresponding to the consuming kernel command kcmd_C are performed by the same processing unit 200, the virtual address VAa may be written to the internal register 211, and whether the virtual address VAa is written to the internal register 211 may be determined. For example, a virtual address, 0X8000, may be written to the internal register 211 based on the first additional command acmd1, and the core 240 may determine based on the second additional command acmd2 that the virtual address, 0X8000, has been written to the internal register 211 and execute the consuming kernel command kcmd_C.

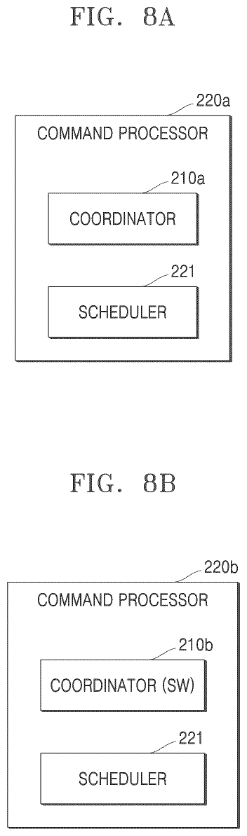

FIGS. 8A and 8B are diagrams illustrating example implementations of a coordinator, according to embodiments. FIG. 8A illustrates an example implementation in which a coordinator 210a is included in a command processor 220a, according to at least one embodiment. FIG. 8B illustrates an example in which a coordinator 210b is implemented by software, according to at least one embodiment. Redundant descriptions given above are omitted below.

Referring to FIG. 8A, the command processor 220a may include the coordinator 210a and a scheduler 221. The coordinator 210a may be configured to determine the type of kernel corresponding to a kernel command (e.g., the kernel command kcmd in FIG. 3) and to generate an additional command according to the type of kernel.

The scheduler 221 may be configured to receive and process kernel commands. Based on a kernel command and an additional command, the scheduler 221 may schedule such that when a consuming kernel is executed, data produced by a producing kernel is referred to.

Compared to FIG. 3, in at least some embodiments, the command processor 220 of FIG. 3 may not include the coordinator 210. In other words, the coordinator 210 may be implemented to be independent of the command processor 220. The command processor 220a of FIG. 8A may include the coordinator 210a and may perform the functions of the coordinator 210a. The coordinator 210 in FIG. 3 may perform functions that are the same as or similar to the functions of the coordinator 210a in FIG. 8A.

Referring to FIG. 8B, a command processor 220b may include the scheduler 221. The coordinator 210b may be implemented by software SW and executed on the command processor 220b. The command processor 220b may determine the type of kernel corresponding to a kernel command by executing the coordinator 210b and may generate an additional command according to the type of kernel.

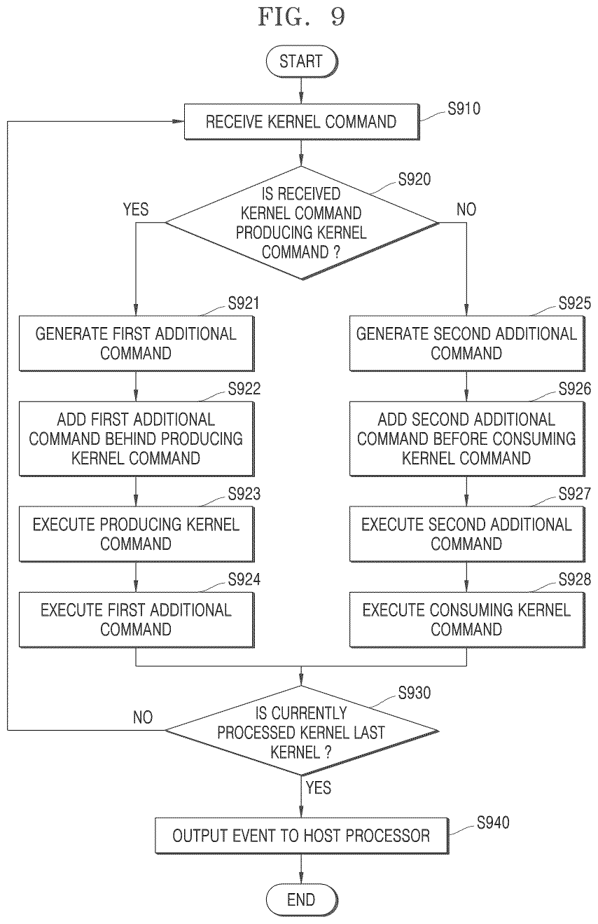

FIG. 9 is a flowchart of an operating method of a processing unit, according to at least one embodiment. Redundant descriptions given above are omitted below. Hereinafter, FIG. 1 is also referred to.

The processing unit 200 may receive a kernel command in operation S910. The processing unit 200 may receive the kernel command from the host processor 100. The processing unit 200 may perform an operation corresponding to the kernel command.

The processing unit 200 may determine the type of kernel command in operation S920. The processing unit 200 may determine whether the received kernel command is a producing kernel command. When receiving the producing kernel command, the processing unit 200 may determine that the producing kernel command has been received and may perform operation S921. When a producing kernel command is not received, the processing unit 200 may determine that a consuming kernel command has been received and may perform operation S925.

For example, the coordinator 210 may determine the type of kernel corresponding to the kernel command. The coordinator 210 may receive at least one of the producing kernel command and the consuming kernel command. The producing kernel command may correspond to a producing kernel and may request to execute the producing kernel. The consuming kernel command may correspond to a consuming kernel and may request to execute the consuming kernel.

The processing unit 200 may generate an additional command according to the type of kernel. Specifically, the coordinator 210 may generate a different additional command according to the type of kernel. The coordinator 210 may generate a different additional command according to the type of kernel command. The coordinator 210 may generate an additional command such that the consuming kernel is executed by referring to data produced by the producing kernel.

When receiving the producing kernel command, the processing unit 200 may generate a first additional command in operation S921. The first additional command may request to write an identifier corresponding to the producing kernel command to an internal register of the processing unit 200.

The processing unit 200 may add the first additional command behind the producing kernel command in operation S922. The processing unit 200 may add the first additional command behind the producing kernel command to follow the producing kernel command.

The processing unit 200 may execute the producing kernel command in operation S923. The processing unit 200 may execute a producing kernel based on the producing kernel command. The processing unit 200 may store a result of executing the producing kernel in a memory (e.g., the memory 300 in FIG. 4), based on the producing kernel command. When operation S923 is completely performed, operation S924 may be performed.

The processing unit 200 may execute the first additional command in operation S924. When the execution of the producing kernel command is completed, an identifier corresponding to the producing kernel command may be written to the internal register, based on the first additional command.

When the producing kernel command is not received, the processing unit 200 may determine that the consuming kernel command has been received and may generate a second additional command in operation S925. The processing unit 200 may generate the second additional command in correspondence to the consuming kernel command. The second additional command may request to wait until an identifier corresponding to the consuming kernel command is written to the internal register of the processing unit 200. When the identifier corresponding to the consuming kernel command is written to the internal register, execution of the second additional command may be terminated.

The processing unit 200 may add the second additional command before the consuming kernel command in operation S926. The processing unit 200 may add the second additional command before the consuming kernel command to precede the consuming kernel command. The second additional command may be executed first, and then, the consuming kernel command may be executed.

The processing unit 200 may execute the second additional command in operation S927. The processing unit 200 may check, based on the second additional command, whether the identifier corresponding to the consuming kernel command is written to the internal register and may wait until the identifier is written to the internal register. When the identifier corresponding to the consuming kernel command is written to the internal register, it may indicate that the execution of the producing kernel has been completed. The processing unit 200 may execute a consuming kernel by referring to an execution result of the producing kernel.

The processing unit 200 may execute the consuming kernel command in operation S928. The processing unit 200 may execute a consuming kernel based on the consuming kernel command. The processing unit 200 may execute the consuming kernel by referring to the execution result of the producing kernel, which has been stored in the memory. The processing unit 200 may execute the consuming kernel by referring to data produced by the producing kernel and may store, in the memory, a result of executing the consuming kernel.

The processing unit 200 may determine whether a currently processed kernel is the last kernel in operation S930. The processing unit 200 may determine whether the currently processed kernel is the last kernel among the kernels included in a neural network. The processing unit 200 may perform operation S940 when the currently processed kernel is the last kernel and may newly perform operation S910 when the currently processed kernel is not the last kernel.

The processing unit 200 may output the event EVT to the host processor 100 in operation S940. The processing unit 200 may output, to the host processor 100, the event EVT indicating a neural network processing result.

FIG. 10 is a diagram illustrating a first processing unit and a second processing unit, according to at least one embodiment. The host processor 100 in FIG. 10 may correspond to the host processor 100 in FIG. 1, and a first processing unit 200_1 and a second processing unit 200_2 in FIG. 10 may each correspond to the processing unit 200 in FIG. 1. Thus, redundant descriptions thereof may be omitted below. Although it is illustrated in FIG. 10 that the electronic device 10 includes two processing units 200, this is just an example. The electronic device 10 may include three or more processing units 200.

Referring to FIG. 10, the electronic device 10 may include a plurality of processing units 200. One of the processing units 200 may receive one of the consuming kernel command kcmd_C and the producing kernel command kcmd_P, and another processing unit 200 may receive the other one of the consuming kernel command kcmd_C and the producing kernel command kcmd_P. The electronic device 10 may include the host processor 100, the first processing unit 200_1, and the second processing unit 200_2. For example, the electronic device 10 may include different types of processing units 200. For example, the first processing unit 200_1 may correspond to an NPU, and the second processing unit 200_2 may correspond to a GPU. However, this is just an example, and embodiments are not limited thereto. The electronic device 10 may include the same type of processing units 200.

The first processing unit 200_1 may receive the producing kernel command kcmd_P. The first processing unit 200_1 may receive the producing kernel command kcmd_P from the host processor 100. The first processing unit 200_1 may execute a producing kernel based on the producing kernel command kcmd_P. Because the first processing unit 200_1 receives the producing kernel command kcmd_P, the first processing unit 200_1 may be a producer.

The first processing unit 200_1 may include a first coordinator 210_1 and a first command processor 220_1. The first coordinator 210_1 may determine the type of kernel corresponding to the kernel command kcmd and may generate an additional command according to the type of kernel. The first coordinator 210_1 may determine that the kernel corresponding to the producing kernel command kcmd_P is a producing kernel.

The first coordinator 210_1 may generate the first additional command acmd1 corresponding to the producing kernel command kcmd_P. The first additional command acmd1 may request to write an identifier corresponding to the producing kernel command kcmd_P to a first register 211_1 inside the first coordinator 210_1. The first coordinator 210_1 may add the first additional command acmd1 behind the producing kernel command kcmd_P to follow the producing kernel command kcmd_P.

The first command processor 220_1 may schedule a kernel command and an additional command. The first command processor 220_1 may schedule such that the first additional command acmd1 is executed after the producing kernel command kcmd_P is executed. The first command processor 220_1 may schedule such that after a producing kernel is executed based on the producing kernel command kcmd_P, an operation corresponding to the first additional command acmd1 first additional command acmd1 is performed based on the first additional command acmd1.

The first processing unit 200_1 may execute the producing kernel, store data produced by the producing kernel in a memory inside the electronic device 10, and write an identifier corresponding to the producing kernel command kcmd_P to the first register 211_1, based on the first additional command acmd1.

The second processing unit 200_2 may receive the consuming kernel command kcmd_C. The second processing unit 200_2 may receive the consuming kernel command kcmd_C from the host processor 100. The second processing unit 200_2 may execute a consuming kernel based on the consuming kernel command kcmd_C. Because the second processing unit 200_2 receives the consuming kernel command kcmd_C, the second processing unit 200_2 may be a consumer.

The second processing unit 200_2 may include a second coordinator 210_2 and a second command processor 220_2. The second coordinator 210_2 may determine the type of kernel corresponding to the kernel command kcmd and may generate an additional command according to the type of kernel. The second coordinator 210_2 may determine that the kernel corresponding to the consuming kernel command kcmd_C is a consuming kernel.

The second coordinator 210_2 may generate the second additional command acmd2 corresponding to the consuming kernel command kcmd_C. The second additional command acmd2 may be a command for waiting until an identifier corresponding to the consuming kernel command kcmd_C is written to a second register 211_2 inside the second coordinator 210_2 and then terminating the execution thereof when the identifier corresponding to the consuming kernel command kcmd_C is written to the second register 211_2. The second coordinator 210_2 may add the second additional command acmd2 before the consuming kernel command kcmd_C to precede the consuming kernel command kcmd_C.

The second command processor 220_2 may schedule such that the consuming kernel command kcmd_C is executed after the second additional command acmd2 is executed. The second command processor 220_2 may schedule such that after an operation corresponding to the second additional command acmd2 is performed based on the second additional command acmd2, the consuming kernel is executed based on the consuming kernel command kcmd_C.

After the second processing unit 200_2 waits based on the second additional command acmd2 until the identifier corresponding to the consuming kernel command kcmd_C is written to the second register 211_2, the second processing unit 200_2 may execute the consuming kernel by referring to the data stored in the memory, based on the consuming kernel command kcmd_C.

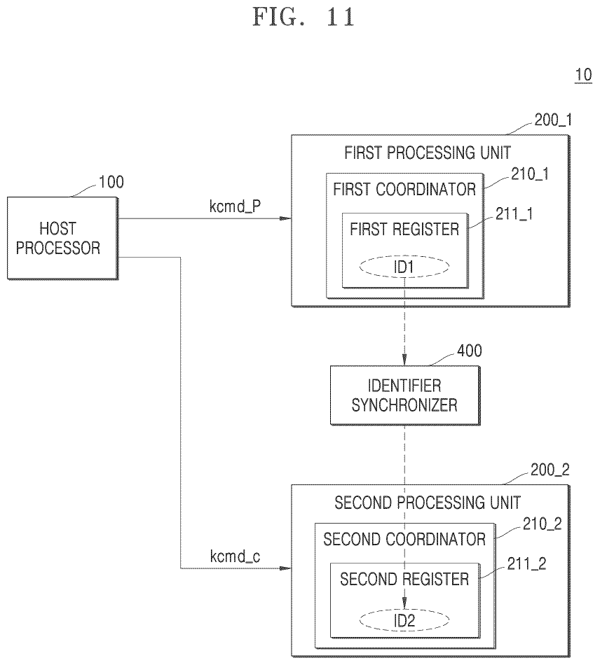

FIG. 11 is a block diagram illustrating an identifier synchronizer, according to at least one embodiment. The electronic device 10 of FIG. 11 may further include an identifier synchronizer 400. Redundant descriptions given above with reference to FIG. 10 are omitted below.

Referring to FIG. 11, the electronic device 10 may include the identifier synchronizer 400. When a producing kernel is completely executed by the first processing unit 200_1, the second processing unit 200_2 may need to recognize that the execution of the producing kernel has been completed by the first processing unit 200_1, so as to execute a consuming kernel by referring to the producing kernel. The second processing unit 200_2 may execute the consuming kernel when the execution of the producing kernel is completed by the first processing unit 200_1.

The identifier synchronizer 400 may inform the second processing unit 200_2 when the execution of the producing kernel by the first processing unit 200_1 is completed. In at least one embodiment, when a first identifier ID1 is written to the first register 211_1 of the first processing unit 200_1, the identifier synchronizer 400 may write a second identifier ID2 to the second register 211_2 of the second processing unit 200_2. The first identifier ID1 may correspond to the producing kernel command kcmd_P, and the second identifier ID2 may correspond to the consuming kernel command kcmd_C.

For example, the identifier synchronizer 400 may monitor the first register 211_1 and may write the second identifier ID2 to the second register 211_2 when the first identifier ID1 is written to the first register 211_1. However, embodiments are not limited thereto. The identifier synchronizer 400 may write the second identifier ID2 to the second register 211_2 when the identifier synchronizer 400 receives, from the first coordinator 210_1, a signal indicating that the first identifier ID1 is written to the first register 211_1.

In at least one embodiment, the first identifier ID1 may be the same as the second identifier ID2. An identifier corresponding to the producing kernel command kcmd_P may be the same as an identifier corresponding to the consuming kernel command kcmd_C. For example, when the first identifier ID1 is written to the first register 211_1, the identifier synchronizer 400 may write, as the second identifier ID2, the same identifier as the first identifier ID1 to the second register 211_2. When the second identifier ID2 is written to the second register 211_2, the second processing unit 200_2 may execute the consuming kernel command kcmd_C by referring to data produced by a producing kernel.

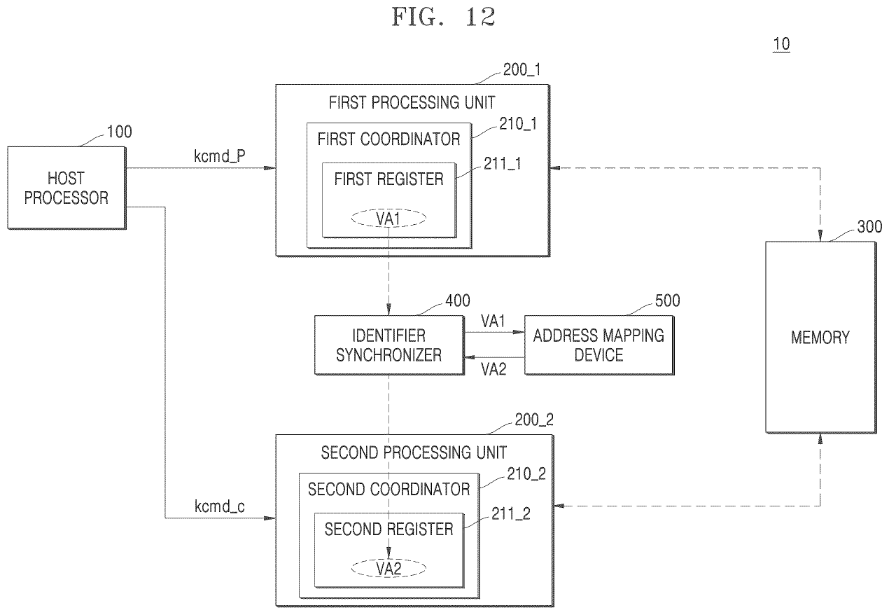

In at least one embodiment, the first identifier ID1 may be different from the second identifier ID2. An identifier corresponding to the producing kernel command kcmd_P may be different from an identifier corresponding to the consuming kernel command kcmd_C. For example, when the first identifier ID1 is written to the first register 211_1, the identifier synchronizer 400 may write, as the second identifier ID2, an identifier different from the first identifier ID1 to the second register 211_2. For example, the first identifier ID1 may correspond to a first virtual address, and the second identifier ID2 may correspond to a second virtual address. The first virtual address and the second virtual address are described in detail with reference to FIG. 12 below.

FIG. 12 is a diagram illustrating a case in which an identifier is a virtual address, according to at least one embodiment. Redundant descriptions given above are omitted below.

Referring to FIGS. 11 and 12, the first identifier ID1 may correspond to a first virtual address VA1 and the second identifier ID2 may correspond to a second virtual address VA2. A producing kernel may be executed based on the producing kernel command kcmd_P, and data produced by executing the producing kernel may be stored in the memory 300. The first virtual address VA1 may be a virtual address to the memory 300 accessed by the first processing unit 200_1. The second virtual address VA2 may be a virtual address to the memory 300 accessed by the second processing unit 200_2. The host processor 100 may transmit the first virtual address VA1 to the first processing unit 200_1 and the second virtual address VA2 to the second processing unit 200_2.

The first processing unit 200_1 may execute a producing kernel based on the producing kernel command kcmd_P and store data in the memory 300. For example, the first processing unit 200_1 may store the data in a position in the memory 300, which is indicated by the first virtual address VA1 received from the host processor 100. The first processing unit 200_1 may execute a first additional command and may write the first virtual address VA1 to the first register 211_1. For example, the first virtual address VA1 written to the first register 211_1 as the first identifier ID1 may indicate a position in the memory 300, in which data resulting from execution of a producing kernel has been stored.

The identifier synchronizer 400 may inform the second processing unit 200_2 when the execution of the producing kernel is completed by the first processing unit 200_1. In at least one embodiment, when the first virtual address VA1 is written to the first register 211_1 as the first identifier ID1, the identifier synchronizer 400 may write the second virtual address VA2 to the second register 211_2 as the second identifier ID2. For example, the second virtual address VA2 written to the second register 211_2 as the second identifier ID2 may be mapped to the first virtual address VA1 written to the first register 211_1. The second virtual address VA2 written to the second register 211_2 may indicate a position in the memory 300, in which data referred to by a consuming kernel is stored.

In at least one embodiment, the identifier synchronizer 400 may convert the first virtual address VA1 into the second virtual address VA2. The identifier synchronizer 400 may convert the first virtual address VA1, which is written to the first register 211_1, into the second virtual address VA2, which is mapped to a physical address that is mapped to the first virtual address VA1. In other words, the first virtual address VA1 written to the first register 211_1 and the second virtual address VA2 written to the second register 211_2 may correspond to the same physical address.

The identifier synchronizer 400 may read the first virtual address VA1 from the first register 211_1, convert the first virtual address VA1 into the second virtual address VA2 corresponding to the first virtual address VA1, and write the second virtual address VA2 to the second register 211_2. In at least one embodiment, the identifier synchronizer 400 may include a reader which reads the first virtual address VA1 from the first register 211_1, a requester which requests to convert the first virtual address VA1 into the second virtual address VA2 corresponding to the first virtual address VA1, a receiver which receives the second virtual address VA2 corresponding to the first virtual address VA1 from an address mapping device 500, and a writer which writes the second virtual address VA2 to the second register 211_2. However, embodiments are not limited thereto. Components of the identifier synchronizer 400 may be added or omitted according to operational needs.

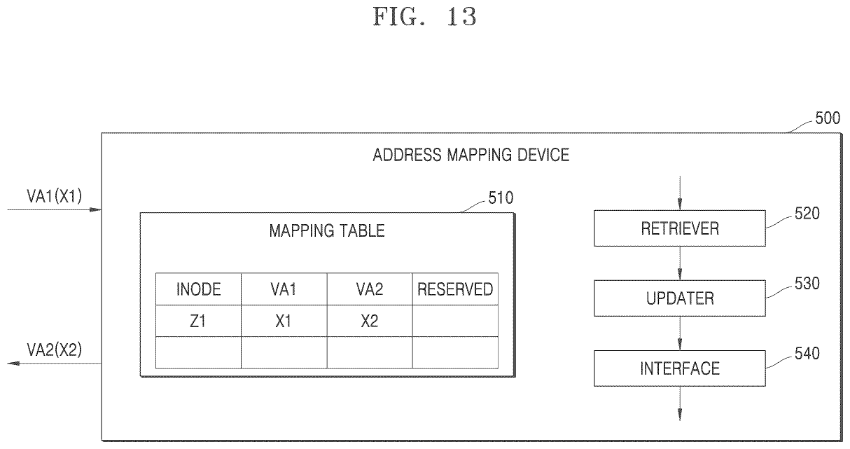

The address mapping device 500 may convert the first virtual address VA1 into the second virtual address VA2 corresponding to the first virtual address VA1. The address mapping device 500 may receive, from the identifier synchronizer 400, a conversion request with respect to the first virtual address VA1 and may send the second virtual address VA2 corresponding to the first virtual address VA1 to the identifier synchronizer 400. For example, the address mapping device 500 may map the first virtual address VA1 to the second virtual address VA2. Although it is illustrated in FIG. 12 that the identifier synchronizer 400 and the address mapping device 500 are separate from each other, this is just an example. The identifier synchronizer 400 and the address mapping device 500 may be configured as a single device. The address mapping device 500 is described with reference to FIG. 13 below.

When the second virtual address VA2 is written to the second register 211_2, the second processing unit 200_2 may execute the consuming kernel command kcmd_C. The second processing unit 200_2 may wait based on a second additional command until the second virtual address VA2 is written to the second register 211_2 and may then execute the consuming kernel command kcmd_C.

For example, the second processing unit 200_2 may refer to data stored in a position in the memory 300, which is indicated by the second virtual address VA2 received from the host processor 100. The first virtual address VA1 and the second virtual address VA2, which are transmitted from the host processor 100, may correspond to the same physical address. A position in the memory 300, which the first processing unit 200_1 accesses based on the first virtual address VA1 to store an execution result of a producing kernel, may be the same as a position in the memory 300, which the second processing unit 200_2 accesses based on the second virtual address VA2 to refer to the execution result of the producing kernel when executing a consuming kernel.

Result data generated by the second processing unit 200_2 executing a consuming kernel may be stored in the memory 300. The second virtual address VA2 received by the second processing unit 200_2 to refer to data produced by a producing kernel may be different from a virtual address used to store the result data of the consuming kernel. The virtual address used to store the result data of the consuming kernel may be transmitted from the host processor 100 to the second processing unit 200_2. In the memory 300, a position in which the result data of the producing kernel is stored may be different from a position in which the result data of the consuming kernel is stored, and virtual addresses respectively indicating the positions may be different from each other.

FIG. 13 is a block diagram illustrating the address mapping device 500 according to at least one embodiment. The address mapping device 500 of FIG. 13 may correspond to the address mapping device 500 in FIG. 12. Redundant descriptions given above may be omitted below.

Referring to FIG. 13, the address mapping device 500 may include a mapping table 510, a retriever 520, an updater 530, and an interface 540. The mapping table 510 may be stored in a memory. For example, the mapping table 510 may be stored in an internal memory of the address mapping device 500. However, embodiments are not limited thereto.

The mapping table 510 may be configured to store virtual addresses (e.g., VA1 and VA2) and an inode. In a state where different types of processing units share a memory, the mapping table 510 may store virtual addresses (e.g., VA1 and VA2) for each type of processing unit and an inode which identifies a physical address for identifying each of the virtual addresses (e.g., VA1 and VA2). The inode may include an index that represents and identifies various virtual addresses (e.g., VA1 and VA2) corresponding to a single physical address. For example, when the first virtual address VA1 mapped to a physical address, Y1, is X1 and the second virtual address VA2 mapped to the physical address, Y1, is X2, the inode, Z1, may be set to identify the physical address, Y1, corresponding to virtual addresses, X1 and X2. The mapping table 510 may include a reserved space to reflect changes or the like of a processing unit. Although it is illustrated in FIG. 13 that two virtual addresses (e.g., VA1 and VA2) are mapped to one inode, embodiments are not limited thereto. The number of virtual addresses mapped to one inode may be set based on types of processing units, such as CPU, GPU, and NPU.

The retriever 520 may receive the first virtual address VA1 from an identifier synchronizer (e.g., the identifier synchronizer 400 in FIG. 12). The retriever 520 may receive, from the identifier synchronizer 400, a request to convert the first virtual address VA1 into the second virtual address VA2. The retriever 520 may check whether the second virtual address VA2 corresponding to the first virtual address VA1 is in the mapping table 510. For example, the retriever 520 may check whether the first virtual address VA1 is in the mapping table 510.

When the first virtual address VA1 is in the mapping table 510, the retriever 520 may acquire the second virtual address VA2 mapped to the first virtual address VA1 in the mapping table 510. For example, when the first virtual address VA1 is X1, the retriever 520 may acquire X2 that is the second virtual address VA2 because X1 is in the mapping table 510. When the first virtual address VA1 is not in the mapping table 510, the retriever 520 may acquire the second virtual address VA2 through memory mapping.

When the first virtual address VA1 is not in the mapping table 510 (e.g., when an inode corresponding to the first virtual address VA1 is not in the mapping table 510) the updater 530 may store the first and second virtual addresses VA1 and VA2 and the inode corresponding thereto in the mapping table 510.

The interface 540 may transmit the second virtual address VA2 to the identifier synchronizer 400. For example, the interface 540 may transmit X2, which is acquired as the second virtual address VA2, to the identifier synchronizer 400.

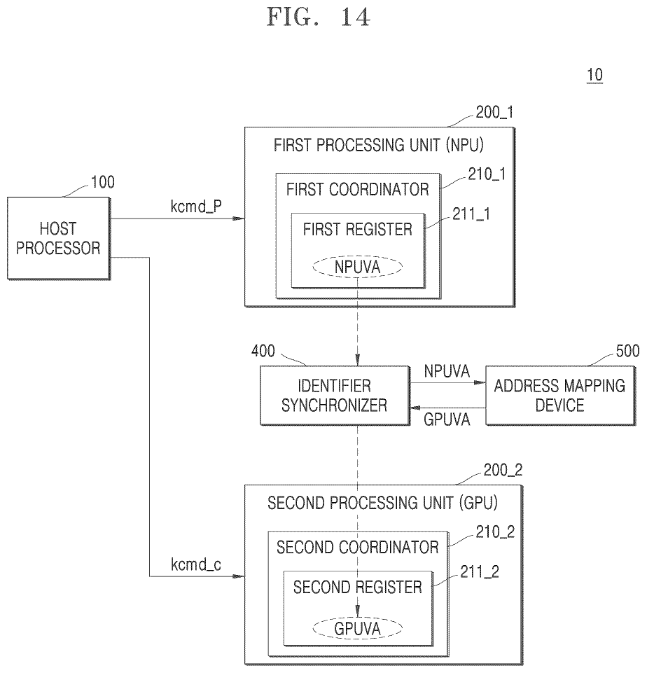

FIG. 14 is a diagram illustrating a case in which processing devices are an NPU and a GPU, according to at least one embodiment. FIG. 14 is described assuming that the first processing unit 200_1 is an NPU and the second processing unit 200_2 is a GPU. Redundant descriptions given above are omitted below. FIG. 12 is also referred to below.

Referring to FIGS. 12 and 14, the first processing unit 200_1 may be an NPU and the second processing unit 200_2 may be a GPU. The first processing unit 200_1 may receive the producing kernel command kcmd_P. In other words, the NPU may receive the producing kernel command kcmd_P and execute a producing kernel. The second processing unit 200_2 may receive the consuming kernel command kcmd_C. In other words, the GPU may receive the consuming kernel command kcmd_C and execute a consuming kernel.

Because the first processing unit 200_1 is an NPU, the first virtual address VA1 may be an NPU virtual address NPUVA. The NPU virtual address NPUVA may correspond to a first identifier (e.g., the first identifier ID1 in FIG. 11). Because the second processing unit 200_2 is a GPU, the second virtual address VA2 may be a GPU virtual address GPUVA. The GPU virtual address GPUVA may correspond to a second identifier (e.g., the second identifier ID2 in FIG. 11).

The first processing unit 200_1 may store data in a position in the memory 300, which is indicated by the NPU virtual address NPUVA. The first processing unit 200_1 may execute a first additional command and write, to the first register 211_1, the NPU virtual address NPUVA to which the data has been stored.

When the NPU virtual address NPUVA is written to the first register 211_1 as the first identifier ID1, the identifier synchronizer 400 may write the GPU virtual address GPUVA to the second register 211_2 as the second identifier ID2. The identifier synchronizer 400 may convert the NPU virtual address NPUVA into the GPU virtual address GPUVA. The identifier synchronizer 400 may request the address mapping device 500 to convert the NPU virtual address NPUVA. The address mapping device 500 may map the NPU virtual address NPUVA to the GPU virtual address GPUVA and may send the GPU virtual address GPUVA to the identifier synchronizer 400. The identifier synchronizer 400 may write the GPU virtual address GPUVA to the second register 211_2.

The second processing unit 200_2 may execute the consuming kernel command kcmd_C when the GPU virtual address GPUVA is written to the second register 211_2. The second processing unit 200_2 may execute a consuming kernel by referring to data stored in the memory 300, based on the GPU virtual address GPUVA.

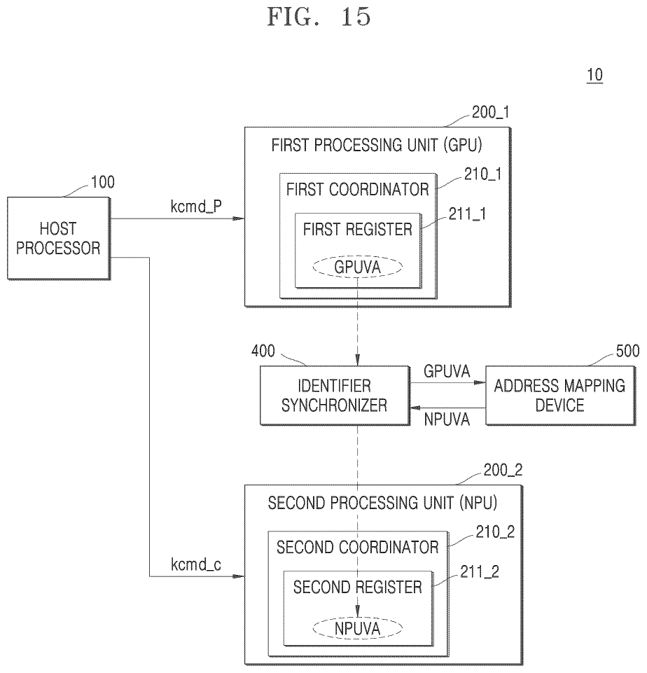

FIG. 15 is a diagram illustrating a case in which processing devices are a GPU and an NPU, according to at least one embodiment. FIG. 15 is described assuming that the first processing unit 200_1 is a GPU and the second processing unit 200_2 is an NPU. Redundant descriptions given above may be omitted below. FIG. 12 is also referred to below.

Referring to FIGS. 12 and 14, the first processing unit 200_1 may be a GPU and the second processing unit 200_2 may be an NPU. The GPU may receive the producing kernel command kcmd_P and execute a producing kernel. The NPU may receive the consuming kernel command kcmd_C and execute a consuming kernel.

Because the first processing unit 200_1 is a GPU, the first virtual address VA1 may be the GPU virtual address GPUVA. The GPU virtual address GPUVA may correspond to a first identifier (e.g., the first identifier ID1 in FIG. 11). Because the second processing unit 200_2 is an NPU, the second virtual address VA2 may be the NPU virtual address NPUVA. The NPU virtual address NPUVA may correspond to a second identifier (e.g., the second identifier ID2 in FIG. 11).

The first processing unit 200_1 may store data in a position in the memory 300, which is indicated by the GPU virtual address GPUVA. The first processing unit 200_1 may execute a first additional command and write, to the first register 211_1, the GPU virtual address GPUVA to which the data has been stored.

When the GPU virtual address GPUVA is written to the first register 211_1, the identifier synchronizer 400 may write the NPU virtual address NPUVA to the second register 211_2. The identifier synchronizer 400 may request the address mapping device 500 to convert the GPU virtual address GPUVA. The address mapping device 500 may map the GPU virtual address GPUVA to the NPU virtual address NPUVA and may send the NPU virtual address NPUVA to the identifier synchronizer 400. The identifier synchronizer 400 may write the NPU virtual address NPUVA to the second register 211_2.

The second processing unit 200_2 may execute the consuming kernel command kcmd_C when the NPU virtual address NPUVA is written to the second register 211_2. The second processing unit 200_2 may execute a consuming kernel by referring to data stored in the memory 300, based on the NPU virtual address NPUVA.

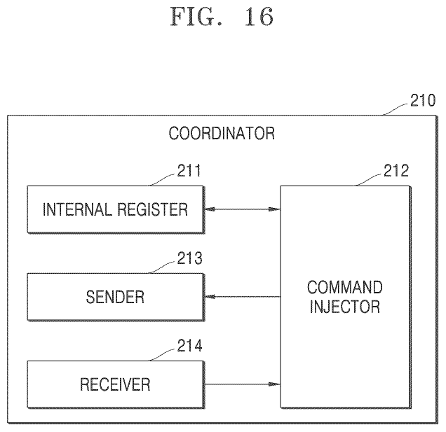

FIG. 16 is a block diagram of the coordinator 210 according to at least one embodiment. The coordinator 210 of FIG. 16 corresponds to the coordinator 210 in FIG. 3, and thus, redundant descriptions thereof are omitted.

Referring to FIG. 16, the coordinator 210 may include a sender 213, a receiver 214, the internal register 211, and a command injector 212. However, embodiments are not limited thereto. For example, components may be added to or omitted from the coordinator 210. Although it is illustrated that the internal register 211 is included in the coordinator 210, embodiments are not limited thereto. The internal register 211 may be outside the coordinator 210.

The command injector 212 may be configured to determine the type of kernel corresponding to a kernel command and generate an additional command according to the type of kernel. The command injector 212 may generate a different additional command according to the type of kernel. The command injector 212 may output an additional command corresponding to a kernel command.

In at least one embodiment, when receiving a producing kernel command, the command injector 212 may generate a first additional command. When receiving a consuming kernel command, the command injector 212 may generate a second additional command. The command injector 212 may add the first additional command behind the producing kernel command to follow the producing kernel command. The command injector 212 may add the second additional command before the consuming kernel command to precede the consuming kernel command.

The sender 213 may send an identifier. For example, when the coordinator 210 is used for a producer, the sender 213 may send an identifier. For example, the sender 213 may send an identifier to an identifier synchronizer (e.g., the identifier synchronizer 400 in FIG. 11).

The receiver 214 may receive an identifier. For example, when the coordinator 210 is used for a consumer, the receiver 214 may receive an identifier. The identifier received by the receiver 214 may be written to the internal register 211.

As described above with reference to FIGS. 1 to 15, the coordinator 210 may be included in the processing unit 200. However, embodiments are not limited thereto. Some functions of the coordinator 210 may be performed by a host processor (e.g., the host processor 100 in FIG. 1). In at least one embodiment, the command injector 212 may be included in the host processor 100. This is described below with reference to FIGS. 18 and 19.

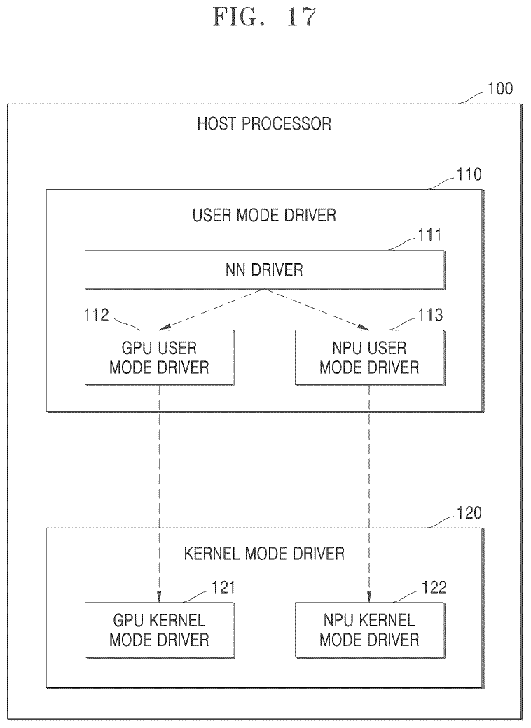

FIG. 17 is a diagram illustrating the host processor 100 according to at least one embodiment. Redundant descriptions given above may be omitted below.

The host processor 100 may include the user mode driver 110 and the kernel mode driver 120. The user mode driver 110 may not access important parts (e.g., a kernel address region) of a system but may drive a program (or an application) requested by a host or a user.

The user mode driver 110 may include a neural network driver (hereinafter, referred to as an NN driver) 111, a GPU user mode driver 112, and an NPU user mode driver 113. The NN driver 111 may drive various programs for processing a neural network. The NN driver 111 may determine a processing unit (e.g., the processing unit 200 in FIG. 1) that executes a kernel. For example, the NN driver 111 may determine which of an NPU and a GPU executes a kernel.

The GPU user mode driver 112 and the NPU user mode driver 113 may execute an API for neural network processing. For example, when a kernel is determined to be executed by a GPU, the GPU user mode driver 112 may execute an API for neural network processing and may access a library for executing the kernel. For example, when a kernel is determined to be executed by an NPU, the NPU user mode driver 113 may execute an API for neural network processing and may access a library for executing the kernel.

The kernel mode driver 120 may include a GPU kernel mode driver 121 and an NPU kernel mode driver 122. A kernel mode may include an execution mode in which OS services may be provided and a mode in which access to all systems and memory is allowed. The kernel mode driver 120 may manage resources of the processing unit 200.

Host programs, commands, etc., may be transmitted through the user mode driver 110 and the kernel mode driver 120 to the processing unit 200 outside the host processor 100. Data or signals received from the processing unit 200 may be input to storage of the user mode driver 110 through the kernel mode driver 120 and the user mode driver 110.

FIG. 18 is a diagram illustrating an example in which a host processor includes a command injector, according to at least one embodiment. Referring to FIG. 18, command injectors 212_1 and 212_2 may be included in the user mode driver 110.

The user mode driver 110 may include the command injectors 212_1 and 212_2. In at least one embodiment, the GPU user mode driver 112 and the NPU user mode driver 113 may respectively include the command injectors 212_1 and 212_2. For example, the GPU user mode driver 112 may include the command injector 212_1, and the NPU user mode driver 113 may include the command injector 212_2.

When a kernel is determined to be executed by a GPU, the command injector 212_1 may receive a kernel command from the NN driver 111. The kernel command received by the command injector 212_1 may be transmitted to the GPU. When receiving a producing kernel command, the command injector 212_1 may add a first additional command behind the producing kernel command so that the producing kernel command and the first additional command are output. The producing kernel command and the first additional command may be transmitted to the GPU. When receiving a consuming kernel command, the command injector 212_1 may add a second additional command before the consuming kernel command so that the second additional command and the consuming kernel command are output. The second additional command and the consuming kernel command may be transmitted to the GPU.

When a kernel is determined to be executed by an NPU, the command injector 212_2 may receive a kernel command from the NN driver 111. The kernel command received by the command injector 212_2 may be transmitted to the NPU. When receiving a producing kernel command, the command injector 212_2 may add a first additional command behind the producing kernel command so that the producing kernel command and the first additional command are output. The producing kernel command and the first additional command may be transmitted to the NPU. When receiving a consuming kernel command, the command injector 212_2 may add a second additional command before the consuming kernel command so that the second additional command and the consuming kernel command are output. The second additional command and the consuming kernel command may be transmitted to the NPU.

FIG. 19 is a diagram illustrating an example in which a host processor includes a command injector, according to at least one embodiment. Compared to FIG. 18, command injectors 212_3 and 212_4 may be included in the kernel mode driver 120.

Referring to FIG. 19, the kernel mode driver 120 may include the command injectors 212_3 and 212_4. In at least one embodiment, the GPU kernel mode driver 121 and the NPU kernel mode driver 122 may respectively include the command injectors 212_3 and 212_4. For example, the GPU kernel mode driver 121 may include the command injector 212_3, and the NPU kernel mode driver 122 may include the command injector 212_4.

When a kernel is determined to be executed by a GPU, the command injector 212_3 may receive a kernel command from the NN driver 111 through the GPU user mode driver 112. The kernel command received by the command injector 212_3 may be transmitted to the GPU. When receiving a producing kernel command, the command injector 212_3 may add a first additional command behind the producing kernel command so that the producing kernel command and the first additional command are output. The producing kernel command and the first additional command may be transmitted to the GPU. When receiving a consuming kernel command, the command injector 212_3 may add a second additional command before the consuming kernel command so that the second additional command and the consuming kernel command are output. The second additional command and the consuming kernel command may be transmitted to the GPU.

When a kernel is determined to be executed by an NPU, the command injector 212_4 may receive a kernel command from the NN driver 111 through the NPU user mode driver 113. The kernel command received by the command injector 212_4 may be transmitted to the NPU. When receiving a producing kernel command, the command injector 212_4 may add a first additional command behind the producing kernel command so that the producing kernel command and the first additional command are output. The producing kernel command and the first additional command may be transmitted to the NPU. When receiving a consuming kernel command, the command injector 212_4 may add a second additional command before the consuming kernel command so that the second additional command and the consuming kernel command are output. The second additional command and the consuming kernel command may be transmitted to the NPU.

While the inventive concepts have been particularly shown and described with reference to embodiments thereof, it will be understood that various changes in form and details may be made therein without departing from the spirit and scope of the following claims.

What is claimed is:

1. A processing unit for processing a neural network, the processing unit comprising:
a coordinator configured to
receive a kernel command from a host processor. the kernel command enabling an execution of kernels for a neural network process,
determine a type of at least one of the kernels corresponding to the kernel command, the types of kernel including a producing kernel configured to produce data and a consuming kernel configured to refer to the data, and
generate a different additional command based on the determined type of kernel; and
a command processor configured to, based on the kernel command and the additional command, schedule the neural network process such that the data produced by the producing kernel is referred to when the consuming kernel is executed.

2. The processing unit of claim 1, wherein the coordinator is further configured to
generate a first additional command based on receiving a producing kernel command corresponding to the producing kernel, the first additional command requesting to write an identifier corresponding to the producing kernel command to an internal register of the processing unit, and
generate a second additional command based on receiving a consuming kernel command corresponding to the consuming kernel, the second additional command requesting to wait until an identifier corresponding to the consuming kernel command is written to the internal register of the processing unit.

3. The processing unit of claim 2, wherein, the coordinator is further configured to add the first additional command behind the producing kernel command to follow the producing kernel command when the coordinator receives the producing kernel command.

4. The processing unit of claim 2, wherein the coordinator is further configured to add the second additional command before the consuming kernel command to precede the consuming kernel command when the coordinator receives the consuming kernel command.

5. The processing unit of claim 2, wherein
the data is stored in a memory outside the processing unit when the producing kernel is executed based on the producing kernel command, and
the identifier includes a virtual address indicating a position in which the data has been stored in the memory.

6. The processing unit of claim 2, wherein the coordinator is configured to include the internal register.

7. The processing unit of claim 2, wherein the identifier corresponding to the producing kernel command is identical to the identifier corresponding to the consuming kernel command.

8. The processing unit of claim 1, wherein
the processing unit is configured to receive one kernel command among a consuming kernel command corresponding to the consuming kernel and a producing kernel command corresponding to the producing kernel, another processing unit is configured to receive the other kernel command among the consuming kernel command and the producing kernel command, and
an identifier corresponding to the one kernel command received by the processing unit is different from an identifier corresponding to the other kernel command received by the other processing unit.

9. The processing unit of claim 1, wherein the coordinator is included in the command processor.

10. The processing unit of claim 1, wherein the command processor is configured to execute the coordinator.

11. An electronic device comprising:
a first processing unit configured to receive a producing kernel command corresponding to a producing kernel and execute the producing kernel based on the producing kernel command, the producing kernel configured to produce data; and
a second processing unit configured to receive a consuming kernel command corresponding to a consuming kernel and execute the consuming kernel based on the consuming kernel command, the consuming kernel referring to the data,
wherein the first processing unit is further configured to generate a first additional command that requests that an identifier, corresponding to the producing kernel command, be written to a first register of the first processing unit, and
the second processing unit is further configured to generate a second additional command that requests a wait until an identifier, corresponding to the consuming kernel command, is written to a second register of the second processing unit.

12. The electronic device of claim 11, wherein the first processing unit is further configured to,
add the first additional command behind the producing kernel command to follow the producing kernel command when receiving the producing kernel command.

13. The electronic device of claim 11, wherein
the second processing unit is further configured to add the second additional command before the consuming kernel command to precede the consuming kernel command when receiving the consuming kernel command.

14. The electronic device of claim 11, wherein the identifier corresponding to the producing kernel command is identical to the identifier corresponding to the consuming kernel command.

15. The electronic device of claim 11, wherein the identifier corresponding to the producing kernel command is different from the identifier corresponding to the consuming kernel command.

16. The electronic device of claim 15, further comprising:
a memory storing the data produced by executing the producing kernel,
wherein the identifier corresponding to the producing kernel command includes a first virtual address enabling the first processing unit to access the memory,
the identifier corresponding to the consuming kernel command includes a second virtual address used by the second processing unit to access the memory, and
the first virtual address and the second virtual address correspond to a same physical address.

17. The electronic device of claim 11, further comprising:
an identifier synchronizer configured to write the identifier corresponding to the consuming kernel command to the second register of the second processing unit when the identifier corresponding to the producing kernel command is written to the first register of the first processing unit.

18. The electronic device of claim 17, wherein
the identifier corresponding to the producing kernel command includes a first virtual address enabling the first processing unit to access a memory,
the identifier corresponding to the consuming kernel command includes a second virtual address enabling the second processing unit to access the memory, and
the identifier synchronizer is further configured to read the first virtual address from the first register, convert the first virtual address into the second virtual address, and write the second virtual address to the second register.

19. The electronic device of claim 18, further comprising:
an address mapping device configured to receive the first virtual address from the identifier synchronizer, check whether the second virtual address corresponding to the first virtual address is in a mapping table, and transmit the second virtual address to the identifier synchronizer.

20. A host processor comprising:
a user mode driver configured to drive a host program and to generate a kernel command configured to enable executing kernels for neural network processing; and
a kernel mode driver configured to manage resources of a processing unit configured to execute the kernels,
wherein one of the user mode driver and the kernel mode driver includes a command injector configured to generate a different additional command according to a type of the kernel command, enabling referencing between the kernels, and to output the kernel command and the additional command corresponding to the kernel command.
